(19) United States
(12) Patent Application Publication
(10) Pub. No.: US 2002/0082748 A1
(43) Pub. Date: Jun. 27, 2002

(54) Utility monitoring and control systems

(75) Inventors: David A. Enga, Fairfax, VA (US); James C. Enga, Madison, SD (US); James N. Enga, Madison, SD (US); Jill C. Ferratt, Herndon, VA (US); Julie A. Holec, Vienna, VA (US); Evandro V. Viana, Sterling, VA (US); David K. LaVal, Sterling, VA (US)

Correspondence Address: Hall, Priddy, Myers & Vande Sande, Suite 200, 10220 River Road, Potomac, MD, 20854, US

(73) Assignee: Internet Energy Systems, Inc.

(21) Appl. No.: 09/983,992

(22) Filed: Aug. 15, 2001

Related U.S. Application Data
(63) Continuation of application No. 09/881,205, filed on Jun. 15, 2001, now abandoned.
(63) Continuation of application No. 09/882,378, filed on Jun. 18, 2001.
(60) Provisional application No. 60/211,468, filed on Jun. 15, 2000.

(51) Int. Cl. G05D 3/12; G05D 5/00; G05D 9/00; G05D 11/00; G05D 17/00

(52) U.S. Cl. 700/291; 700/295; 700/286

(57) ABSTRACT

A method of communication useful in remote utility demand control systems, automated utility data gathering systems and combined utility demand control and data systems is disclosed. Also disclosed is an utility remote demand control and/or automated data gathering system. Different methods of communications between a utility demand control and consumption tracking unit, which is connected to different utility consuming devices, on the one hand, and a centralized command transmission and data gathering unit, on the other hand, are described. The communication between these units includes at least one computer information network.

### CROSS-REFERENCES TO RELATED APPLICATION

This application claims the benefit under 35 U.S.C. §120 to the filing dates of U.S. Provisional Application, Serial No. 60/211,468, filed Jun. 15, 2000. This application claims the benefit under 35 U.S.C. §120 to the filing dates of and is a continuing application of (1) U.S. Application “UTILITY MONITORING AND CONTROL SYSTEMS,” filed Jun. 15, 2001, Ser. No. 09/881,205 and (2) U.S. Application “UTILITY MONITORING AND CONTROL SYSTEMS,” filed Jun. 18, 2001, Ser. No. 09/882,378.

### INCORPORATION BY REFERENCE

This application incorporates by reference the entire disclosures of U.S. Provisional Application, Serial No. 60/221,468, filed Jun. 15, 2000 and U.S. Application “UTILITY MONITORING AND CONTROL SYSTEMS,” filed Jun. 15, 2001, Ser. No. 09/881,205 and U.S. Application “UTILITY MONITORING AND CONTROL SYSTEMS,” filed Jun. 18, 2001, Ser. No. 09/882,378.

### TECHNICAL FIELD

The invention relates to the monitoring and/or control of demand for any of a variety of utilities, such as electricity, fuels and water. In certain embodiments, the invention relates to both monitoring and controlling the operation of utility consuming devices from a distance.

### BACKGROUND OF THE INVENTION

General Considerations

Expanding awareness of the benefits of automated utility consumption data gathering and control has inspired proposals and activities involving RDC (Remote Demand Control) systems, ADG (Automated Data Gathering) systems and CCD (Combined Control and Data) systems. The latter systems combine at least portions of the functions of RDC and ADG systems.

RDC, ADG and CCD systems can for example gather data on, and/or control, the consumption of one or more utilities. Examples of these include such consumable commodities as electricity, fuel gas, other fuels and/or water (including steam). Among these are commodities that are themselves energy (e.g., electricity), those which are used primarily to release energy (e.g., various fuels) and water, the generation, transmission or transport and uses of all which can have environmental impacts.

The RDC, ADG and CCD systems assist in monitoring and/or controlling consumption of one or more utilities in one or more utility consuming systems. The latter may include, for example a gas furnace, an irrigation system, an air conditioner or an electric hot water heater or a combination of any of these and/or other utility consuming systems.

Locations at which utility consuming systems are installed are referred to as domains. A domain may be a single location or a number of locations. Thus, for example, a domain may be a home, a factory, some other kind of commercial establishment, a government facility, a portion of any of these or a combination of any of them, for example a number of stores operated by a grocery chain.

In RDC, ADG and CCD systems, some system components, which may be referred to as “local” components, are more directly involved than others in controlling and/or monitoring the utility consuming systems and are operationally associated with them. For example, these may include demand control and/or consumption tracking units to be discussed in greater detail below. As a matter of convenience, these more directly involved components are in many instances situated “at” (in, on or near) the location(s) of the utility consuming systems and will usually but not necessarily be located in or near the domains.

To afford opportunity to receive consumption data at, and/or exercise consumption control from, a centralized location, other components of RDC, ADG and CCD systems are usually distanced from, i.e., located at some distance from, the utility consuming systems. Illustrative of such distanced components are centralized data gathering and/or command transmission units.

On the one hand, centralized command transmission and/or data gathering units may represent starting points for the establishment of demand controls and/or end-points for the collection of data. One the other hand, these units may for example serve as communications relay stations rather than starting and/or end-points. When functioning as relay stations, these units can pass control commands directly or indirectly from another starting point and/or can pass consumption messages directly or indirectly from the local components to another unit serving as an end-point. Thus, one, two or more levels of relaying are contemplated. However, even when units participate in command transmission and/or data gathering by acting as communications relay stations rather than starting points and/or end-points, they are still centralized units in their relation to any demand control and/or consumption tracking units with which they may cooperate.

Considerable latitude is possible in the amount of distance between the “local” and centralized components of the RDC, ADG and CCD systems. Some of the factors bearing on this amount are the size of the area over which system operators wish to monitor and/or control demand, the number of utility consuming systems to be monitored and/or controlled in that area, the nature of the communications medium used in communications between the local and centralized components, and the extent of use, if any, of communications relays. Any suitable communications medium may be used, e.g., telephone, pager systems, other RF-based systems, E-mail, TV cable, PLC (power line carrier) and others. An RF-based system with short-range, battery-powered transmitters is one example of a number of different types of systems in which use of communications relays is advantageous and in which distance between the “local” components and the centralized components acting as relays could be a few thousand feet or less, or even less than a hundred feet. In other applications, for example ones in which the communication components and/or medium readily traverse long distances, e.g., long range RF systems, TV cable, E-mail and others, the centralized components may be remote from the local components, e.g., may be a mile or more away, and may be many miles away.

RDC (Remote Demand Control) Systems

In a RDC system the local components include demand control units. Each demand control unit is operationally associated, directly or indirectly, with at least one utility consuming system, located in at least a portion of a utility consumption domain. In response to transmissions from one or more centralized command transmission units via any suitable communications medium, the local components can participate in control of the utility consuming systems. The demand control units can on the basis of specific commands, or on the basis of stored rule sets, alter the operating mode of the utility consuming system, for example in a way that can reduce, level or otherwise alter its utility consumption and/or its consumption pattern. An illustrative demand control unit comprises a communications means, usually a signal receiver, a microprocessor, which is usually employed to process specific demand control commands and/or rule sets, an FCU (Flow Control Unit) and possibly other components.

It is possible to use any kind of communications means that is able to receive command transmissions from the centralized demand control command transmission unit or units. In some cases, the communications means may also transmit to such unit(s). Examples of the types of communication means that can be used are those adapted to work with PLC (power line carrier) signals, digital commands via telephone systems (e.g., modems) and radio signals (receivers and/or transceivers).

The FCU may for example be a control relay, another form of switch, a solenoid-controlled valve or other control device, with or without auxiliaries, operationally associated with the utility consuming systems. The FCU can effect changes in the operating mode of the utility consuming system by, for example, interrupting or reducing the flow of the utility, or acting upon a microprocessor or other control component installed in or otherwise associated with the utility consuming device or in any other suitable manner.

One type of RDC has been in use for a number of years by electric utilities to manage peak loads. As system load approaches capacity, signals can be issued from a centralized command transmission unit, which can for example be situated at a power plant, sub-station and/or other location(s). These signals are issued to the communications means of the demand control units operationally associated with utility consuming systems respectively serving a number of consumption domains.

ADG (Automated Data Gathering) Systems

Although many utility meters are still read visually by utility vendors, proposals for and use of ADGs continue to emerge. In an ADG, as in a RDC system, there are both local and centralized components. Typically, the local components include a plurality of consumption tracking units operationally associated, respectively, with at least one utility consuming system located in at least a portion of a utility consumption domain. Here, the operational association is for the purpose of tracking the consumption of one or more utilities by one or more utility consuming systems in the domain.

By transmitting consumption data to one or more centralized data gathering units distanced from the consumption tracking units, using any suitable communications medium, the local components can participate in monitoring the utility consuming systems. Such data can be used for the purpose of billing users for utility consumption, or of measuring demand, or of ascertaining distribution of demand, or of determining when and how to apply demand controls, or for any combination of these and/or other purposes. Measurements can be taken regularly or sporadically, at long or short time intervals, when and as needed, and the elapsed time periods between measurements may for example range from a minute or less to as long as the normal billing period for the utility.

A typical consumption tracking unit comprises a sensor or sensors that obtain(s) consumption data by “reading” one or more utility meters, communications means to transmit the consumption data over at least one communications path (for example telephone lines, email systems or radio) to the centralized data gathering unit(s) and a data processor with memory and software to store meter readings and manage, or at least assist in managing, the communications functions. ADGs can monitor consumption data for individual utility consuming systems, including a variety of different types of utility consuming systems that are situated in the same domain, for example HVAC units, hot water heaters and other machines or appliances in a home or commercial setting.

ADGs have already been tested for utility meter reading in a number of localities. Although ADGs can be devices distinct from the meters they read, it may well be that future utility meters will incorporate some or all of the components required to perform ADG functions at a utility consumption domain.

CCD (Combined Control and Data) Systems

CCD systems, those which can perform both RDC and ADG functions, have also been proposed. These include local and distant, centralized components.

The local components may for instance be demand control and consumption tracking units as described above in connection with RDC and ADG systems, and additional components may be provided to serve other purposes. Thus, for example, a home, office building or other utility consumption domain may be provided with such local components as one or more microprocessor-equipped controllers, each of which can monitor and exercise control over one or more utility consuming systems in the domain for any of a number of purposes, for example the convenience of those who use the home or office building, conservation of utilities and demand control. For purposes of transmitting commands and data between the controllers and the utility consuming systems within the domain, the controllers and such systems are operationally associated, for example through the electric wiring system of the building, a dedicated wiring circuit, a telephone system in the building, sets of radio transmitters and receivers, a fiber optic system or another communication medium.

The centralized components, distanced from the domain, include at least one centralized command transmission and data gathering unit distanced from at least a portion of said demand control and consumption tracking units. Such centralized components are able to communicate with the communications means of the demand control and consumption tracking units for purposes of transmitting commands to and receiving consumption data from the controllers. According to one example, there is a first centralized control facility, distanced from the domain, through which users of the home, office or other building who are away from the building, can schedule or change the mode of operation of any or some of the utility consuming systems there, such as a HVAC system, a hot water heater or lighting. A second centralized control facility, operated by a utility supplier, can be interconnected with and configured to override commands from the first centralized control facility and the controllers in the building to alter the mode of operation of the utility consuming systems, such as to prevent brown-outs.

Although there has been much progress in the development of RDC (Remote Demand Control) systems, ADG (Automated Data Gathering) systems and CCD (Combined Control and Data) systems, it is believed there is a need for greater simplicity, dependability, or versatility, or a combination of these benefits, in the communications methods and apparatus employed in these systems. The present inventions are intended to meet one or more of these needs, as well as other needs which will become apparent to those skilled in the art upon consideration of the disclosure which follows.

### SUMMARY OF THE INVENTIONS

In general, applicant(s) assert(s) that all novel and non-obvious aspects of and combinations disclosed in the present disclosure are among the inventions to be protected hereby. However, certain preferred aspects of the inventions are summarized below.

One aspect of the disclosure involves a method of communication useful in utility remote demand control systems, automated utility data gathering systems and combined control and data systems. This method comprises, in part, providing a plurality of utility demand control and/or consumption tracking units having communications means. These units are operationally associated with at least one utility consuming system located in at least a portion of a utility consumption domain. There is also provided at least one centralized command transmission and/or data gathering unit distanced from at least a portion of the demand control and/or consumption tracking units. The invention also comprises causing the communications means of the demand control and/or consumption tracking units to have recurring communications with the at least one centralized command transmission and/or data gathering unit via one or more communications media, including at least one computer information network. During at least a portion of these communications, connections are established between, and two-way communications are caused to occur between, the communications means and the at least one centralized command transmission and/or data gathering unit.

Another aspect of the disclosure also involves a method of communication useful in utility remote demand control systems, automated utility data gathering systems and combined control and data systems. Here again, a plurality of utility demand control and/or consumption tracking units are provided which have communications means. These units are operationally associated with at least one utility consuming system located in at least a portion of a utility consumption domain. As in the previous aspect of the invention, there is also provided at least one centralized command transmission and/or data gathering unit distanced from at least a portion of the demand control and/or consumption tracking units. In common with the prior aspect, the communications means of the demand control and/or consumption tracking units are caused to have recurring communications with the at least one centralized command transmission and/or data gathering unit via one or more communications media, including at least one computer information network. However, in the present aspect, during at least a portion of these communications, transmission of consumption data through the communications means to the at least one centralized command transmission and/or data gathering unit is caused to commence uncommanded by any of said data gathering and/or command transmission units.

In another aspect, the invention includes improvements on the foregoing methods in which consumption data and/or commands are transmitted in the same (a) type of path, (b) same format, (c) same communications means, (d) at least in part in a connectionless mode or (e) in the course of the same connection.

Certain apparatus inventions are also disclosed herein. Thus, yet another aspect of the disclosure involves a utility remote demand control and/or automated utility data gathering system. This system comprises a plurality of local subsystems with microprocessors, communications units and software. Such local subsystems respectively represent demand control and/or consumption tracking units. The software comprises code that defines at least one common path for two-way transmissions, via at least one computer information network, between the communications units and at least one remote subsystem constituting at least one command transmission and/or data gathering unit.

Still another aspect involves a utility combined control and data system. It comprises a plurality of local subsystems with microprocessors, communications units and software, said local subsystems respectively representing demand control and consumption tracking units. As in the prior aspect, the software comprises code that defines at least one common path for two-way transmissions, via at least one computer information network. Such transmissions pass between the communications units and at least one remote subsystem constituting at least one command transmission and data gathering unit.

As can be seen in part from the foregoing, the disclosure teaches that advantages can accrue from combining and introducing various forms of commonality into the performance of and equipment for performing at least a portion of the above described RDC and/or ADG functions.

Still other aspects of the invention are among the various preferred and best modes of practicing the invention described below with the aid of the accompanying drawings.

### BRIEF DESCRIPTION OF THE DRAWINGS

FIG. 1 is a schematic diagram of a utility CCD (combined control and data) system, combining the functions of an RDC (remote demand control) system and an ADG (automated data gathering) system.

FIG. 2 is a schematic diagram of a more detailed embodiment of a utility CCD system.

FIG. 3 is a schematic diagram of a DC & CT (demand control and consumption tracking) unit useful in CCD, RDC and ADG systems.

FIG. 4 is a schematic diagram of a more detailed embodiment of a DC & CT unit.

FIG. 5 is a schematic diagram of a wireless DC & CT unit.

FIG. 6 is a schematic diagram of a base unit useful in CCD, RDC and ADG systems.

FIG. 7 is a schematic diagram of a wireless base unit.

FIG. 8 is a schematic diagram of a base unit equipped to communicate over cable TV circuits with a centralized command transmission and data gathering unit.

FIG. 9 is a flow sheet for a communications processor.

FIG. 10 is a flow sheet for a scheduler module.

FIG. 11 is a flow sheet for a polling module.

FIG. 12 is a flow sheet for a firmware main processing loop.

FIG. 13 is a flow sheet for a data acquisition task.

FIG. 14 is a flow sheet for a serial task.

FIG. 15 is a flow of sheet for a network task.

### VARIOUS PREFERRED AND BEST MODES OF PRACTICING THE INVENTIONS

The inventions disclosed herein include a number of improvements upon, alternative embodiments and preferred embodiments, including best modes, of the method and apparatus aspects of the invention described above under Summary of the Inventions. Among these improvements and preferred embodiments are methods, which may be combined with the first and second method modes singly or in any combination, wherein:

a plurality of said utility demand control units and at least one centralized command transmission unit are provided.

a plurality of said utility consumption tracking units and at least one centralized data gathering unit are provided.

a plurality of said utility demand control and consumption tracking units and at least one centralized command transmission and data gathering unit are provided.

there are utility demand control and consumption tracking units that comprise separate but interconnected components that respectively perform demand control and/or consumption tracking functions.

the at least one centralized command transmission and data gathering unit comprises separate but interconnected components that respectively perform command transmission and/or data gathering functions.

at least one of said utility demand control and consumption tracking units is a multi-stage unit comprising a utility demand control and/or consumption tracking first stage station and a plurality of utility demand control and/or consumption tracking second stage stations respectively interconnected with the first stage station, and wherein the first stage station

receives demand control first commands from the at least one centralized command transmission and/or data gathering unit and transmits demand control second commands to at least a portion of the second stage stations, said second commands being identical to or at least in conformity with said first commands, and/or

receives utility consumption first data from at least a portion of the second stage stations and transmits utility consumption second data to the at least one centralized command transmission and/or data gathering unit, said second data

i. being identical to the first data, or

ii. incorporating at least a portion of the first data, or

iii. representing a compilation of the first data, or

iv. being in conformity with said first data.

and, optionally, in any combination

a plurality of said utility demand control and consumption tracking units are multi-stage units respectively comprising a utility demand control and/or consumption tracking first stage station and a plurality of utility demand control and/or consumption tracking second stage stations, and/or

transmissions pass between the first stage stations and the at least one centralized command transmission and/or data gathering unit via said computer information network and transmissions pass between the first and second stations via a different communications medium, and, optionally in practicing this embodiment,

the different communications medium is at least one member selected from the group consisting of electricity supply wiring serving at least a portion of a domain, optical fiber cable, coaxial wire cable, other dedicated wiring, telephone wires, atmospheric infra-red light signals, radio signals, a local area computer network serving at least a portion of a domain, an E-mail system and a cable TV system.

said one or more communications media includes, in addition to said computer information network, at least one member selected from the group consisting of electricity supply wiring serving at least a portion of a domain, optical fiber cable, coaxial wire cable, other dedicated wiring, telephone wires, atmospheric infra-red light signals, radio signals, a local area computer network serving at least a portion of a domain, an E-mail system and a cable TV system.

at least a portion of said communications is/are connectionless.

said communications include transmissions across said network which are connectionless and transmissions via connections on said network.

said communication is at least in part according to at least one or more, in any combination, of the following protocols

TCP/IP protocol, or

connection-oriented protocol, or

HTTP protocol, or

TCP protocol, or

E-mail protocol.

at least a portion of the transmissions from the local subsystems to the at least one remote subsystem continue to progress without interruption until reaching the at least one remote subsystem.

the communications between the local subsystems and the at least one remote subsystem pass through a communications relay.

the operational association of demand control units with utility consuming systems is, at least in part,

through control relays and/or solenoid valves controlling the flow of one or more utilities through utility supply lines serving the utility consuming systems, or

through control relays controlling the flow of utilities through utility supply lines serving the utility consuming systems, and wherein the relays are located at the demand control units.

the operational association of consumption tracking units with utility consuming systems is, at least in part,

through sensors that determine the flow of one or more utilities flowing in utility supply lines serving one or more utility consuming systems in the respective domains, or

through utility flow meters and meter-reading sensors on utility supply lines serving the respective domains, or

through utility flow meters and meter-reading sensors on utility supply lines that supply at least two different kinds of utilities in each of a plurality of the domains, or

through utility flow meters and meter-reading sensors on utility supply lines serving the respective utility consuming systems, or

through utility flow meters and meter-reading sensors on utility supply lines that supply one or more different kinds of utilities to at least two utility consuming systems in each of a plurality of domains.

the at least one computer information network is one or more of

the internet, and/or

an extranet.

the utility demand control and/or consumption tracking units represent local subsystems and at least one of these local subsystems is on

an intranet serving at least a portion of a domain, and/or

a local area network serving at least a portion of a domain.

the utility demand control and/or consumption tracking units are components of a building energy management system.

the utility demand control and/or consumption tracking units represent local subsystems and the at least one centralized command transmission and/or data gathering unit represents at least one remote subsystem, and the local subsystem comprises a computer system which participates in demand control and/or consumption tracking functions and which includes a communications firewall, and this feature may be combined, optionally, with any one or more of the following features

the computer system is included in a local area network which is guarded by the communications firewall, and/or

the firewall is configured to operate in at least one mode selected from the group consisting of packet filtering, application gateway, circuit-level gateway and proxy server, and/or

the firewall is configured to bar initiation by the remote subsystem of connections to the communications means of the local subsystems, and/or

recurring communications of the demand control and/or consumption tracking units of the local subsystems with the at least one centralized command transmission and/or data gathering unit of the remote subsystem are initiated by the local subsystems, and/or

transmissions from the remote subsystem to the local subsystems occur during connections between the remote subsystem and the local subsystems initiated by the local subsystems from behind the firewall, and/or

transmissions from the remote subsystem to the local subsystems occur only during connections between the remote subsystem and the local subsystems initiated by the local subsystems from behind the firewall, and/or

transmission of demand control commands from the at least one remote subsystem to the local subsystems occurs only during connections between the remote subsystem and the local subsystems that are initiated by the local subsystems and in which the local subsystems transmit consumption data to the at least one remote subsystem.

recurring communications of the demand control and/or consumption tracking units of the local subsystems with the at least one centralized command transmission and/or data gathering unit of the remote subsystem are initiated by the local subsystems.

transmission of demand control commands from at least one remote subsystem to local subsystems occurs only during connections between the remote subsystem and the local subsystems that are initiated by the local subsystems.

at least one remote subsystem issues demand control commands that comprise instructions to one or more local subsystems to alter the consumption mode of one or more utility consuming systems, which may for example optionally involve the demand control commands comprising

specific instructions to alter the operating mode of one or more utility consuming systems in one or more domains, and/or

rule sets to be interpreted by the local subsystem to determine when and/or how to alter the operating mode of one or more utility consuming systems in one or more domains, and, optionally, in practicing this embodiment

said rule sets are stored by the local subsystems and replaced or amended from time to time by the remote susbsystem.

demand control commands are issued by at least one remote subsystem

in response to data received by said at least one remote subsystem from local subsystems, or

that are based on data received by said at least one remote subsystem from local subsystems, or

that are developed by said at least one remote subsystem based on data received from local subsystems.

at least one remote subsystem issues commands that comprise instructions to one or more local subsystems to

report consumption data, and/or

set or change their data transmission times or time intervals.

during at least a portion of such communications, time data is issued by said at least one remote subsystem to local subsystems for checking and/or resetting clocks within the local subsystems.

during at least a portion of said communications, connections are established between, and two-way communications are caused to occur between, the communications means and the at least one centralized command transmission and/or data gathering unit.

Among the improvements upon, alternative embodiments and preferred embodiments, including best modes, of the apparatus aspects of the invention are the following. They may be combined with the first and second apparatus modes singly or in any combination, wherein, or comprising:

a plurality of said utility demand control units and at least one centralized command transmission unit.

a plurality of said utility consumption tracking units and at least one centralized data gathering unit.

a plurality of said utility demand control and consumption tracking units and at least one centralized command transmission and data gathering unit.

utility demand control and consumption tracking units that comprise separate but interconnected components that respectively perform demand control and/or consumption tracking functions.

at least one centralized command transmission and data gathering unit which comprises separate but interconnected components that respectively perform command transmission and/or data gathering functions.

at least one of said local subsystems being a multi-stage local subsystem, comprising a utility demand control and/or consumption tracking first stage station and a plurality of utility demand control and/or consumption tracking second stage stations respectively interconnected with the first stage station, wherein the local sub-system microprocessors, communications units and software are configured for the first stage station

to receive demand control first commands from the at least one centralized command transmission and/or data gathering unit and to transmit demand control second commands to at least a portion of the second stage stations, said second commands being identical to or at least in conformity with said first commands, and/or

to receive utility consumption first data from at least a portion of the second stage stations and to transmit utility consumption second data to the at least one centralized command transmission and/or data gathering unit, said second data

V. being identical to the first data, or

vi. incorporating at least a portion of the first data, or

vii. representing a compilation of the first data, or

viii. being in conformity with said first data,

and optionally, whether singly or in combination

a plurality of said utility demand control and consumption tracking units are multi-stage units respectively comprising a utility demand control and/or consumption tracking first stage station and a plurality of utility demand control and/or consumption tracking second stage stations, and/or

the local and remote subsystems are configured to pass transmissions between the first stage stations and the at least one centralized command transmission and/or data gathering unit via said computer information network and to pass transmissions between the first and second stations via a different communications medium, and in practicing this embodiment,

the different communications medium is at least one member selected from the group consisting of electricity supply wiring serving at least a portion of a domain, optical fiber cable coaxial wire cable, other dedicated wiring, telephone wires, infra-red light signals, radio signals, a local area computer network serving at least a portion of a domain, an E-mail system and a cable TV system.

the local and remote subsystems are configured to pass transmissions between those subsystems in part via said computer information network and in part via

one or more different communications media, and/or

at least one member selected from the group consisting of electricity supply wiring serving at least a portion of a domain, optical fiber cable, coaxial wire cable, other dedicated wiring, telephone wires, atmospheric infra-red signals, radio signals, a local area computer network serving at least a portion of a domain, an E-mail system and a cable TV system.

at least a portion of the local subsystems and/or at least a portion of the remote subsystems is/are configured

to permit connectionless transmissions in at least one direction along said path.

to permit connectionless transmissions and transmissions based on connections in at least one direction along said path.

to cause said communication to occur at least in part according to

TCP/IP protocol.

a connection-oriented protocol.

HTTP protocol.

TCP protocol.

E-mail protocol.

to cause at least a portion of the transmissions from the local subsystems to the at least one remote subsystem to continue to progress without interruption until reaching the at least one remote subsystem.

to cause at least a portion of the communications between the local subsystems and the at least one remote subsystem to pass through a communications relay.

there is operational association of demand control units with utility consuming systems which is, at least in part,

through control relays and/or solenoid valves that control the flow of one or more utilities through utility supply lines serving the utility consuming systems, and/or

through control relays that control the flow of utilities through utility supply lines serving the utility consuming systems, and wherein the relays are, located at the demand control units, and/or

through sensors that determine the flow of one or more utilities flowing in utility supply lines serving one or more utility consuming systems in domains, and/or

through utility flow meters and meter-reading sensors on utility supply lines serving domains, and/or

through meters and meter-reading sensors on utility supply lines that supply at least two different kinds of utilities in each of a plurality of domains, and/or

through utility flow meters and meter-reading sensors on utility supply lines serving the respective utility consuming systems, and/or

through utility flow meters and meter-reading sensors on utility supply lines that supply one or more different kinds of utilities to at least two utility consuming systems in each of a plurality of domains.

the at least one computer information network is

the internet, and/or

an extranet.

at least one of the local subsystems is on

an intranet serving at least a portion of a domain, and/or

a local area network serving at least a portion of a domain.

the utility demand control and/or consumption tracking units are components of a building energy management system.

one or more of the local subsystems comprise computer systems which participate in demand control and/or consumption tracking functions and which include communication firewalls and this feature may be combined, optionally, with any one or more of the following features

the computer system is included in a local area network which is guarded by the communications firewall, and/or

the firewall is configured to operate in at least one mode selected from the group consisting of packet filtering, application gateway, circuit-level gateway and proxy server, and/or

the firewall is configured to bar initiation by the remote subsystem of connections to the communications means of the local subsystems, and/or

the local subsystems and/or the remote subsystem comprise software configured to cause said transmissions to occur during connections initiated by the local subsystems, and/or

the local subsystems and/or the remote subsystem comprise software configured to cause transmissions from the remote subsystem to the local subsystems to occur during connections between the remote subsystem and the local subsystems initiated by the local subsystems from behind the firewall, and/or

the local subsystems and/or the remote subsystem comprise software configured to cause transmissions from the remote subsystem to the local subsystems to occur only during connections between the remote subsystem and the local subsystems initiated by the local subsystems from behind the firewall.

the local subsystems and/or the remote subsystem comprise software configured to cause transmission of demand control commands from the at least one remote subsystem to the local subsystems to occur only during connections between the remote subsystem and the local subsystems that are initiated by the local subsystems and in which the local subsystems transmit consumption data to the at least one remote subsystem, and wherein the demand control commands represent specific instructions to alter the operating mode(s) of utility consuming systems in one or more domains.

the local subsystems and/or the remote subsystem comprise software configured to cause transmission of demand control commands from the at least one remote subsystem to the local subsystems to occur only during connections between the remote subsystem and the local subsystems that are initiated by the local subsystems and in which the local subsystems transmit consumption data to the at least one remote subsystem, and wherein the demand control commands comprise rule sets to be interpreted by the remote subsystem to determine when and/or how to alter the operating mode(s) of utility consuming systems in one or more domains, and, optionally, in practicing the present embodiment,

said software is configured to cause said rule sets to be stored by the local subsystems and to permit said rule sets to be replaced or amended from time to time by the remote subsystem.

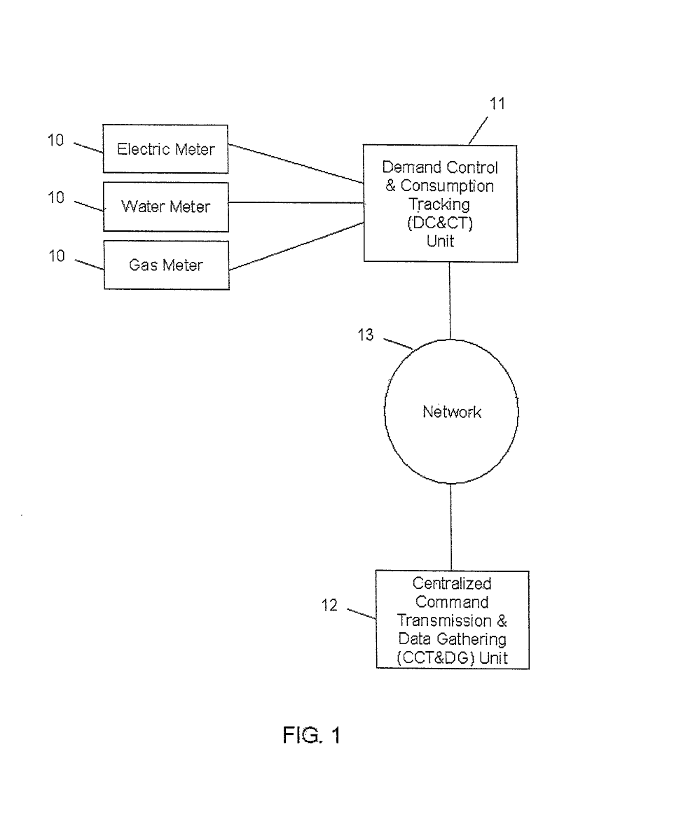

FIG. 1 depicts the overall structure of a utility data & control system according to the present invention.

In a preferred embodiment, a utility demand control and consumption tracking (DC&CT) unit 11 is connected to multiple utility meters 10 and at least one network 13. The utility meters 10 may be of the same or different types, for example electric, water, and gas. Consumption data is collected from the meters 10 by the DC&CT unit 11, e.g. in real time. The collected data is preferably processed and stored by the DC&CT unit 11. The stored consumption data can be transmitted to the centralized command transmission and data gathering (CCT&DG) unit 12 e.g. at configurable intervals.

In this preferred embodiment of the invention a communication means (not shown) in the DC&CT unit 11 initiates a two-way communication channel across the network 13 to the CCT&DG unit 12. In a preferred embodiment this channel is used to transmit data from the DC&CT unit 11 to the CCT&DG unit 12, and, prior to or upon receipt of the data by the CCT&DG unit 12, the CCT&DG unit, in a preferred embodiment, can transmit one or more messages, e.g., data and/or one or more commands, across this communication channel to the DC&CT unit 11. Upon receipt of the message(s) from the CCT&DG unit 12, the DC&CT unit 11 causes, in a preferred embodiment, the communication channel to close. Thus, the communication means of the DC&CT unit 11 initiates two way communications via a network, allowing data to pass both ways between the DC&CT unit 11 and the CCT&DG unit 12.

The transmissions from the CCT&DG unit 12 preferably include, at a minimum, a time value used to synchronize the internal time clock of the DC&CT unit 11. This synchronization can be used to ensure that the time clock of the DC&CT unit 11 does not differ significantly from that of the CCT&DG Unit 12. The messages from the CCT&DG unit 12 may or may not contain different or additional data and/or commands, including but not limited to: notification that the DC&CT unit's 11 stored consumption values should be reset, requests that specific consumption data be transmitted or retransmitted, and configuration changes. Examples of useful configuration changes include but are not limited to: specification of a new CCT&DG unit to which subsequent consumption information should be sent, modification of the time interval between data transmissions to a CCT&DG unit, and changes to rule sets for demand control stored at the DC&CT unit 11.

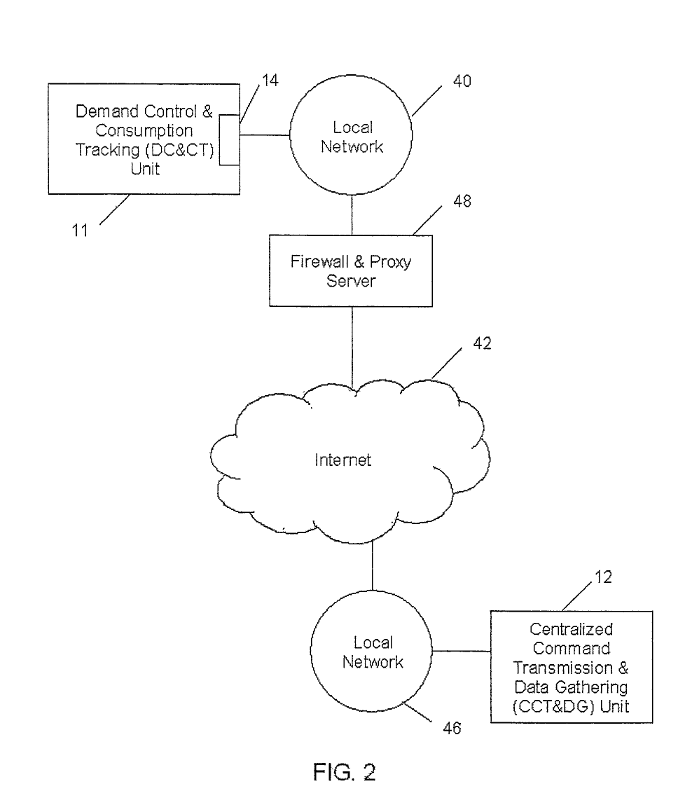

FIG. 2 is an embodiment providing greater detail as to the network connection between DC&CT unit 11 and CCT&DG unit 12. Meters 10 are part of this embodiment, but have been omitted from the figure to simplify it. Here the DC&CT unit 11 is for example installed in a commercial or residential building (not shown). In such an embodiment the DC&CT unit 11 can be connected to a building's local computer network 40 as shown in the figure. In such a setting a firewall 48 often protects the local network by monitoring internet or other traffic to and from the building's local network 40. Firewalls according to the invention include, but are not limited to, those that rely on packet filters, application gateways, circuit level gateways and proxy servers.

In such a system a communication means 14 of the DC&CT unit 11 advantageously initiates a communication channel through the firewall 48 to the CCT&DG unit 12. In one preferred embodiment a TCP/IP socket is created using the IP address of the CCT&DG unit 12 as well as a configurable port number. Once such a socket is created, the communication means 14 can transmit to and receive transmissions from the CCT&DG unit 12 over a communications network 42, e.g. the internet, and a second local network 46 which includes CCT&DG unit 12.

The format of these transmissions may vary depending on the network security policy used by the firewall 48. In a preferred embodiment of the invention, such transmissions include HTTP header information and pass through the firewall as HTTP messages. If desired, the communication means 14 can be configurable to send transmissions according to additional or other well-known protocol headers, such as E-mail, which will enable transmissions to pass in two directions through firewall 48.

Important advantages follow from establishment of a communication channel by the communication means 14 of a DC&CT unit 11 to a CCT&DG unit 12. If CCT&DG unit 12 is outside a physical network 40 of which the DC&CT unit 11 is part, the CCT&DG unit 12 can send one or more messages to the DC&CT unit 11 without having to initiate the communications. Thus, when such a physical network 40 is protected by a firewall, such as firewall 48, initiation of communication by a communication means 14 located inside the firewall allows incoming messages to pass through the firewall even though the firewall is not configured to allow incoming connections from the CCT&DG unit 12. Another advantage of this embodiment is that it facilitates/permits communications when the configuration of the DC&CT unit 11 is changed, e.g. by a command which, e.g., specifies a different CCT&DG unit to which consumption data should be sent. Advantageously this can be done with no interruption to the regular operation of the DC&CT unit 11.

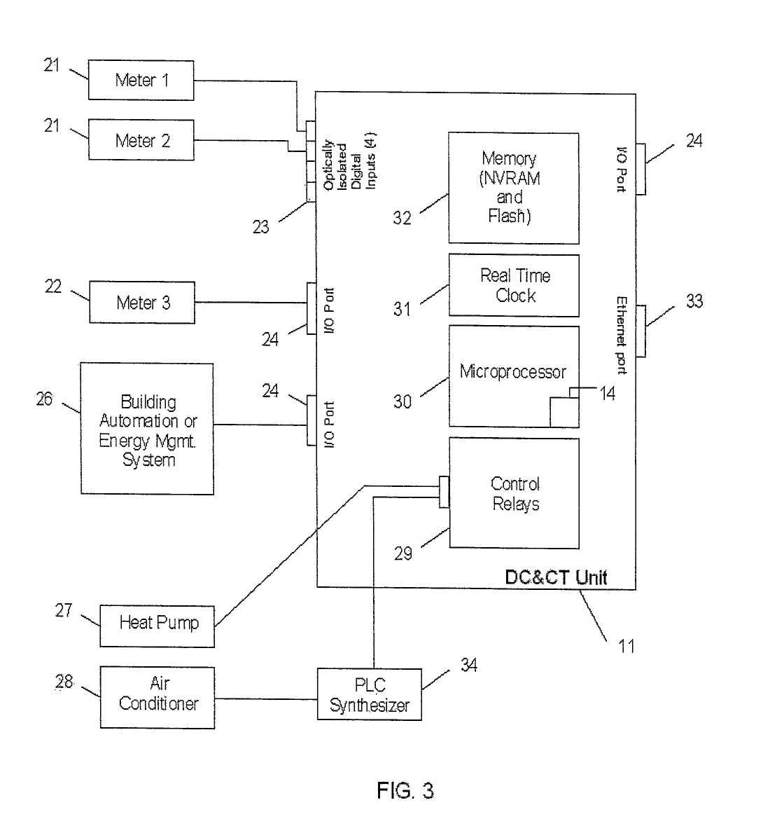

FIG. 3 shows another more detailed and preferred embodiment of the DC&CT unit 11. Here a microprocessor 30 can execute software that is stored in memory 32 of the DC&CT unit 11. Memory 32 can e.g. take the form of non-volatile random access memory (NVRAM) or flash memory and is used to store, e.g., (a) data received from the attached meters 21, 22 such as consumption data and (b) transmissions received from the CCT&DG unit 12, for example one ore more items of configuration information, timing data, specific demand control commands and demand control rules to be applied by DC&CT unit 11.

In a preferred embodiment, one or more pulse meters 21 are connected to the DC&CT unit 11 via optically isolated digital inputs 23. FIG. 3 for example shows two pulse meters connected to two of four such inputs 23. DC&CT unit 11, in accordance with this preferred embodiment, has input/output (I/O) ports 24, e.g. two of those ports. One of the I/O ports 24 may, e.g., be used to connect an electronic meter 22 to the DC&CT unit 11. In such a unit, consumption data can be collected in the form of digital pulse data via the digital inputs 23 and/or in the form of data received via a I/O port 24.

In a further preferred aspect shown in FIG. 3, the DC&CT unit 11 is connected to a network via an ethernet port 33. In such an embodiment network communications initiated by the communication means 14 can utilize this ethernet port 33 and transfer data using, e.g., a TCP/IP messaging protocol to establish, optionally, a two-way communication channel that can be used to, e.g., transmit a message to the DC&CT unit 11 to synchronize its internal time clock with that of the CCT&DG unit 12.

The DC&CT unit 11 as shown in FIG. 3 may execute demand control via different mechanisms, three of which are shown.

If for example a building has an existing building automation or energy management system 26, the DC&CT unit 11 may exercise demand control over that system using, e.g., communications across I/O port 24. Specific details of the communications are dependent on the nature of the particular building automation or energy management system 26.

The DC&CT unit 11 may also include one or more control relays 29 that can be used to e.g. manipulate the consumption mode of a device. Control relay 29 may be directly connected to a device, such as a heat pump 27. Alternatively, a control relay may be indirectly connected to a device, such as air conditioner 28, e.g., through a PLC synthesizer 34. Thus, e.g., to turn the air conditioner 28 on or off, the control relay 29 directs PLC synthesizer 34 to issue an appropriate PLC signal to air conditioner 28. The relays might also be located outside the DC&CT unit 11.

In one embodiment of the invention, an I/O port 24 may be used to connect the DC&CT unit 11 to a personal computer such as for diagnostic purposes or for loading memory 32. In this way, software to be executed by microprocessor 30 can be loaded into memory 32 from the PC using I/O port 24.

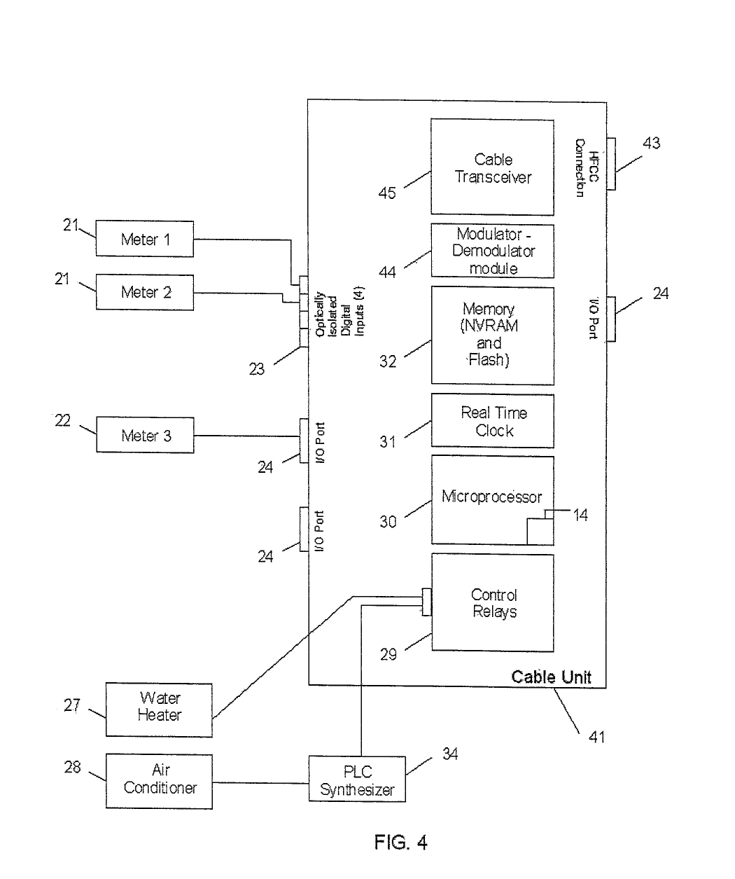

FIG. 4 shows another preferred embodiment of the DC&CT unit 11. Here DC&CT unit 14 (hereinafter referred to as “cable unit 41”) is shown in detail. Cable unit 41 is adapted to communicate with a CCT&DG unit 12 via a base unit 61 (not shown), which will be described in more detail. The cable unit 41 and the base unit 61 communicate via a cable line such as a hybrid fiber-optic/coaxial cable line.

A data signal (in analog form) sent to the cable unit 41 via an analog medium such as a cable line is picked up by the cable transceiver 45 and is passed along to the modulator-demodulator module 44. Module 44 de-modulates the analog data signal and converts it to a digital signal that can be used by microprocessor 30.

On the other hand, before transmitting a message, the module 44 modulates the digital signal from the microprocessor 30 into an analog signal. The analog signal is transmitted, that is placed onto the cable line, by the cable transceiver 45. In a preferred embodiment the cable transceiver 45 uses separate frequencies to transmit and receive data.

The module 44 can use different methods to de-modulate analog signals to digital and modulate digital signals into analog signals. “Keying” techniques such as amplitude shift keying, phase shift keying, frequency shift keying, including but not limited to gaussian frequency shift keying, minimum shift keying, orthogonal frequency shift keying and quadrature frequency shift keying may be used to practice this embodiment of the invention.

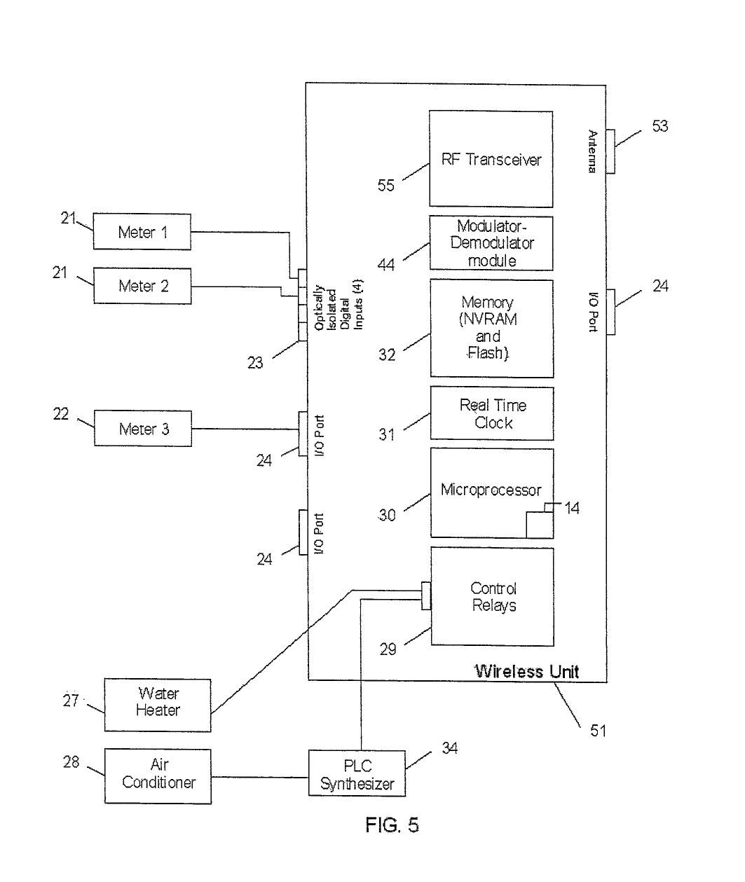

FIG. 5 shows another preferred embodiment of the DC&CT unit 11. Here DC&CT unit 51 (hereinafter referred to as “wireless unit 51”) is shown in detail. Wireless unit 51 is adapted to communicate with a CCT&DG unit 12 via a base unit 61, which will be described in more detail below. Wireless unit 51 and base unit 61 communicate via radio frequency.

A data signal (in analog form) sent to the wireless unit 51 is picked up by radio frequency transceiver 55 and is passed along to the modulator-demodulator module 44. The module 44 de-modulates the analog signal and converts it to a digital signal that can be used by the microprocessor 30.

On the other hand, before transmitting a message, the module 44 modulates the digital signal from the microprocessor 30 into an analog signal. The analog signal is transmitted by the radio frequency transceiver 55. In a preferred embodiment the radio frequency transceiver 55 uses the same frequency to transmit and receive data.

The module 44 can use the methods described under FIG. 4 to demodulate analog signals and modulate digital signals into analog signals.

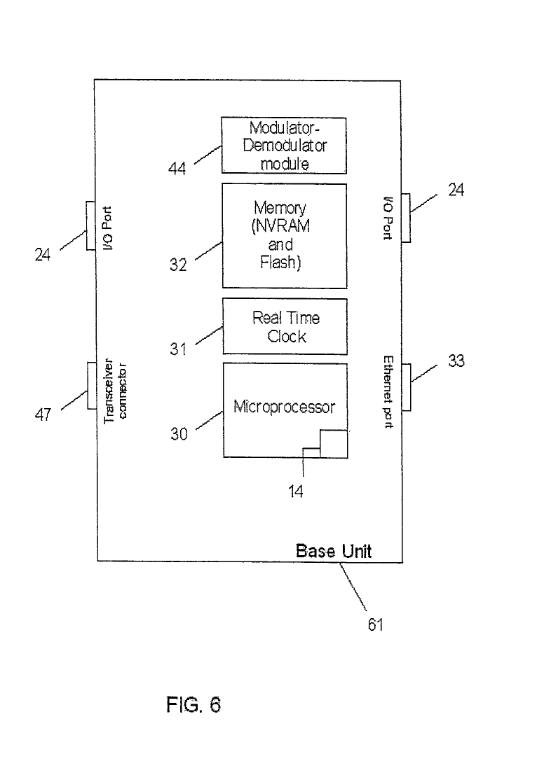

FIG. 6 shows another preferred embodiment of the DC&CT unit 11, namely DC&CT system 61 (hereinafter referred to as “base unit 61”) which provides a link between a cable unit 41 and/or wireless unit 51 on the one hand and a CCT&DG unit 12 on the other. Thus, in a preferred embodiment, the base unit 61 has a serial port 24 and/or an ethernet port 33 as well as a transceiver connector 47 or a built in transceiver. The base unit 61 will, in contrast to the other DC&CT units 11 disclosed herein, often control utility consuming systems indirectly as in cable unit 41 and wireless unit 51, base unit 61 preferably contains or is associated with a modulator-demodulator module 44. The module 44 allows conversion of analog data messages to digital and vice versa. Appropriate conversion methods have been described under FIG. 4. In a preferred embodiment the base unit 61 has a connection 47 to connect to, e.g., an external transceiver, such as a radio transceiver 62 or a cable transceiver 64. However, the transceiver can also be an integral part of base unit 61.

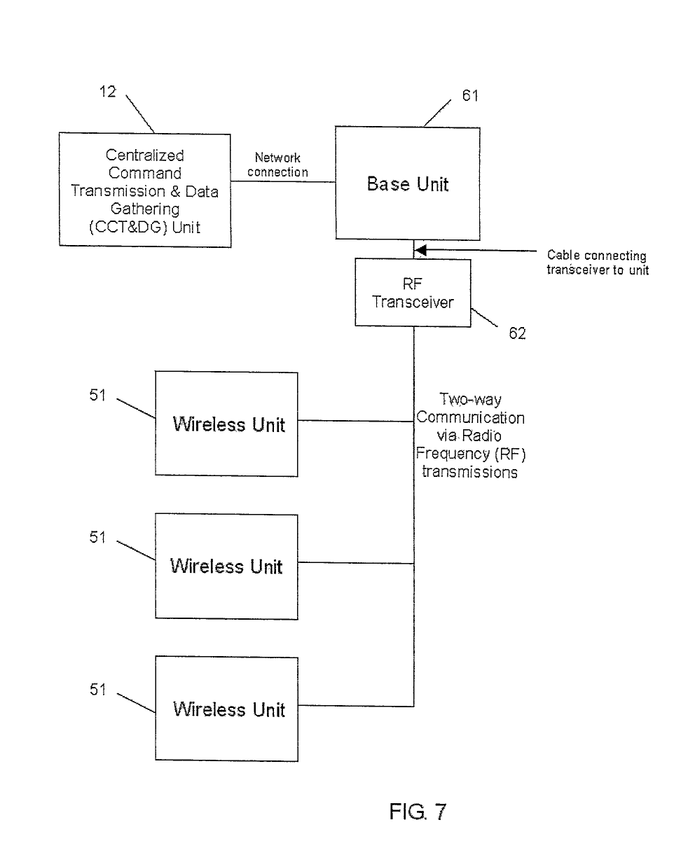

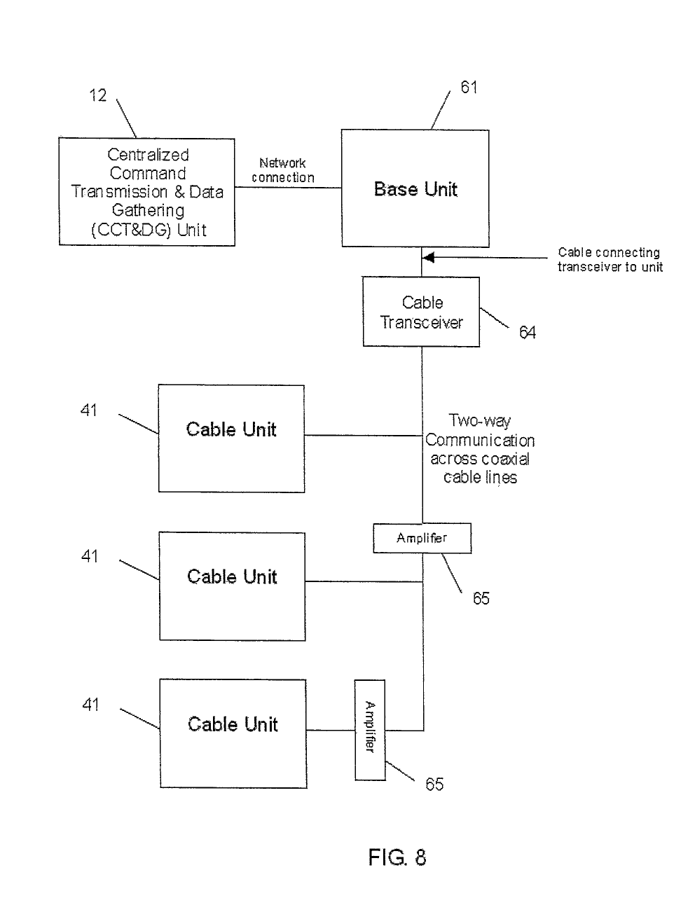

FIGS. 7 and 8 show the base unit 61 of FIG. 6 in context.

In FIG. 7 the base unit 61 is connected to an external RF transceiver 62 allowing the base unit 61 to communicate with one or more wireless units 51. The external radio transceiver should preferably be configured to transmit and/or receive on the frequency or frequencies used by the radio transceiver 55 of the at least one wireless unit 51 it communicates with. In a preferred embodiment the base unit 61 communicates with CCT&DG unit 12 via a serial connection 24 or via ethernet port 33 via a computer network. In one embodiment plural units 61 take part in the communication between the wireless units 51 and a CCT&DG unit 12. This embodiment is particularly useful if large distances or transmission barriers between the wireless unit 51 and the base unit 61 have to be overcome.

In FIG. 8 the base unit 61 is connected to an external cable transceiver 64 allowing the base unit 61 to communicate with one or more cable units 41. The external cable transceiver should preferably be configured to transmit and/or receive on the frequency or frequencies compatible, that is, in a preferred embodiment, receive on the frequency on which the cable transceiver of cable unit transmits and vice versa, with the frequency or frequencies it receives from the internal cable transceiver 45 of the at least one cable units 41 it communicates with. In a preferred embodiment the base unit 61 communicates with CCT&DG unit 12 e.g. via a serial connection 24 or via ethernet port 33 via a computer network. In one embodiment the amplifiers 65 are provided between the base unit 61 and the CCT&DG unit 12. This embodiment is particularly useful if large distances between the base unit 61 and the CCT & cable units 41 have to be overcome.

In one embodiment data is polled by the CCT&DG unit 12 from cable unit 41 and/or wireless unit 51. A preferred embodiment of system processes performed by the CCT&DG unit 12 to manage and facilitate such polling is described in more detail below under the heading “description of selected system processes of the CCT&DG unit 12”.

Description of Selected System Processes of the Centralized Command Transmission and Data Gathering Unit 12

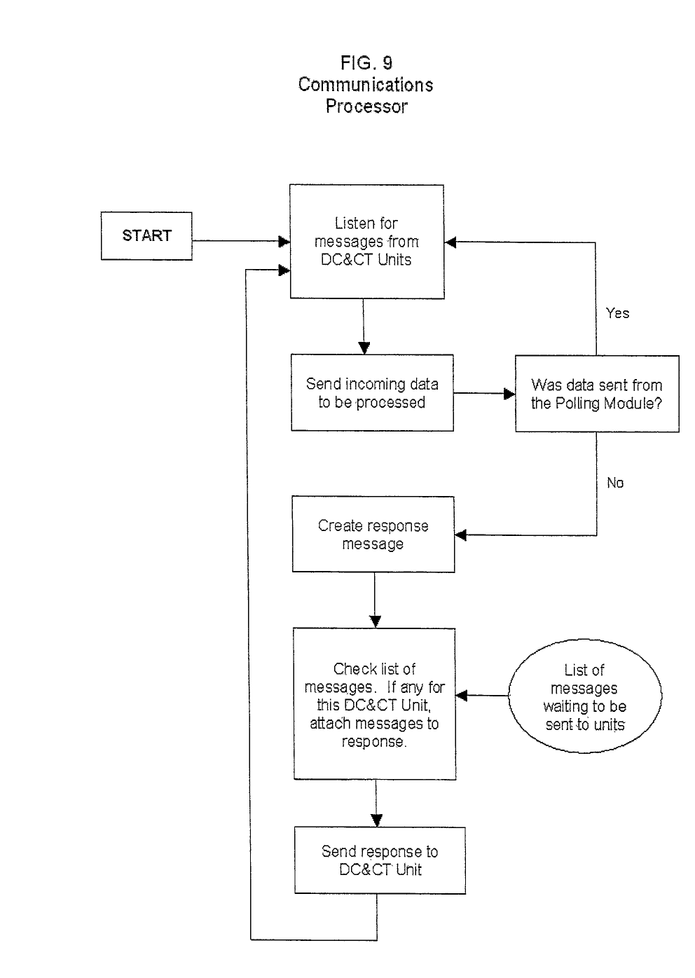

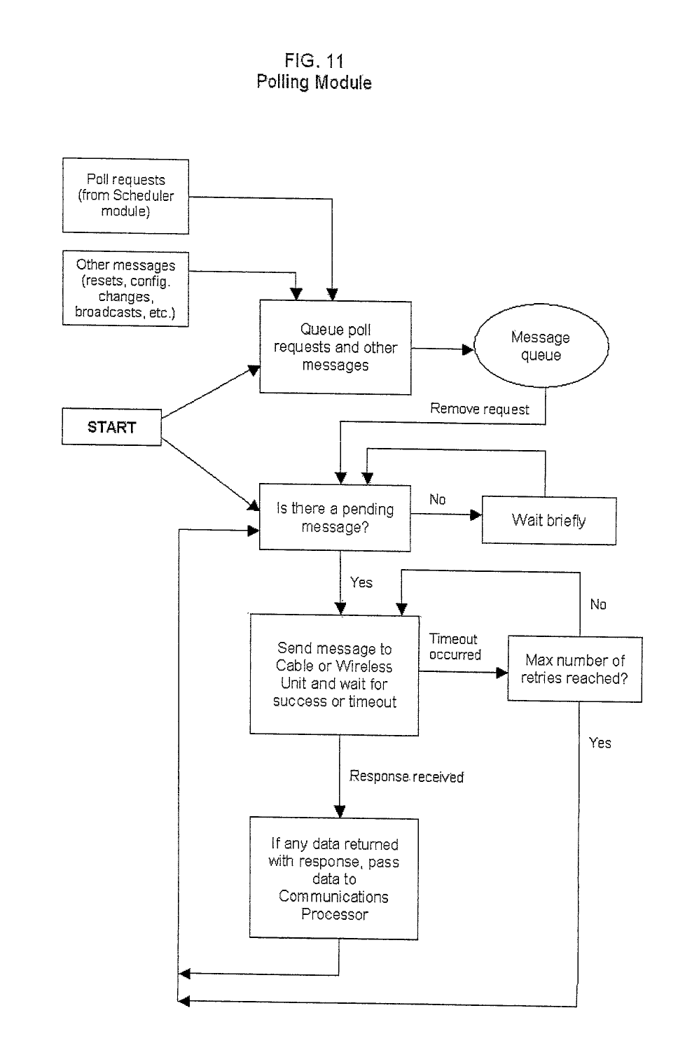

FIG. 9 is a flow diagram of a preferred embodiment of a communications processor. In this preferred embodiment, the communications processor listens for incoming messages from DC&CT units 11. The messages may come directly from a DC&CT unit 11, or may be sent by a polling module as shown in FIG. 11. In a preferred embodiment the communications processor receives messages, and sends them to an appropriate module such as a data base module for processing. If a message is received directly from a DC&CT unit 11, the communications processor can, in a preferred embodiment, generate a response message. If any additional messages generated by other modules are waiting to be sent to the respective DC&CT unit 11, the communications processor, in a preferred embodiment, attaches those additional messages to the response message.

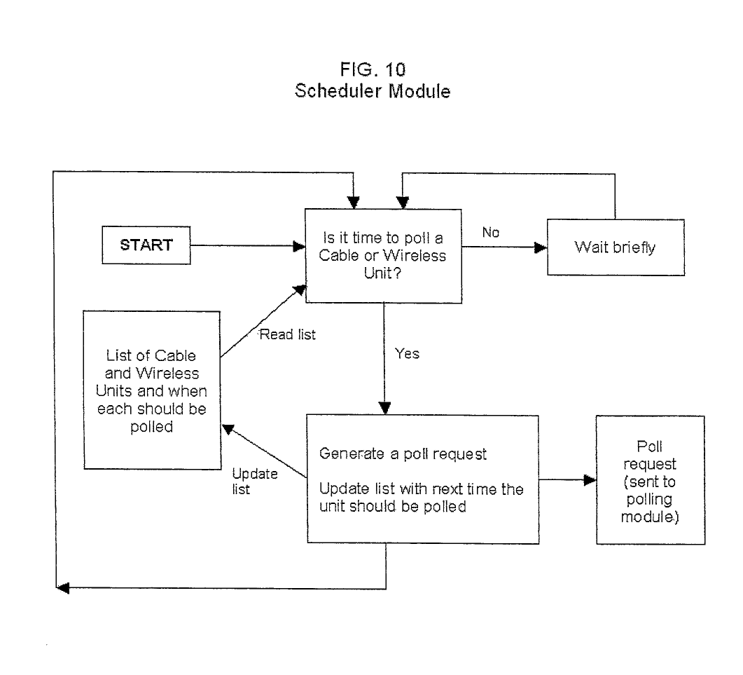

FIG. 10 is a flow diagram of a preferred embodiment of a scheduler module. In a preferred embodiment a scheduler module manages the polling of one or more cable units 41 and/or one or more wireless units 51. In a preferred embodiment, the module keeps a “schedule” containing a list of cable and/or wireless units and of the next time each unit should be polled and relies on the system clock. Thus, the scheduler may, in a preferred embodiment, at a set time generate a poll request and sends the request to the polling module. In a preferred embodiment the scheduler is also capable of determining the next polling time for one or more cable or wireless units and updating the schedule of the units.

FIG. 11 is a flow diagram of a preferred embodiment of a polling module. In a preferred embodiment, the polling module transmits messages generated by scheduler module and messages requesting consumption data to one or more cable units 41 and/or wireless units 41. The polling module may also transmit messages generated by other modules, such as messages requesting resets, configuration changes, broadcast messages, and demand control messages. In a preferred embodiment, the polling module maintains a list of pending messages. In another preferred embodiment, pending messages are removed from the list after being sent by the polling module to the appropriate cable and/ or wireless unit. In another preferred embodiment the polling module will, after sending a message, wait for either an indication of successful transmission or for a timeout. If a timeout occurs, the polling module will, in a preferred embodiment, attempt to resend the message. In another preferred embodiment, the polling module ceases its attempts to transmit after a set number of retries. If the transmission is a success, the polling module, in a preferred embodiment, may or may not, depending on the type of message sent, receive a response. If a response is received, the polling module can, in one embodiment, pass the response to the communications processor for processing.

Description of Selected System Processes of the Utility Demand Control and Consumption Tracking Unit 11

Firmware Processing Loop

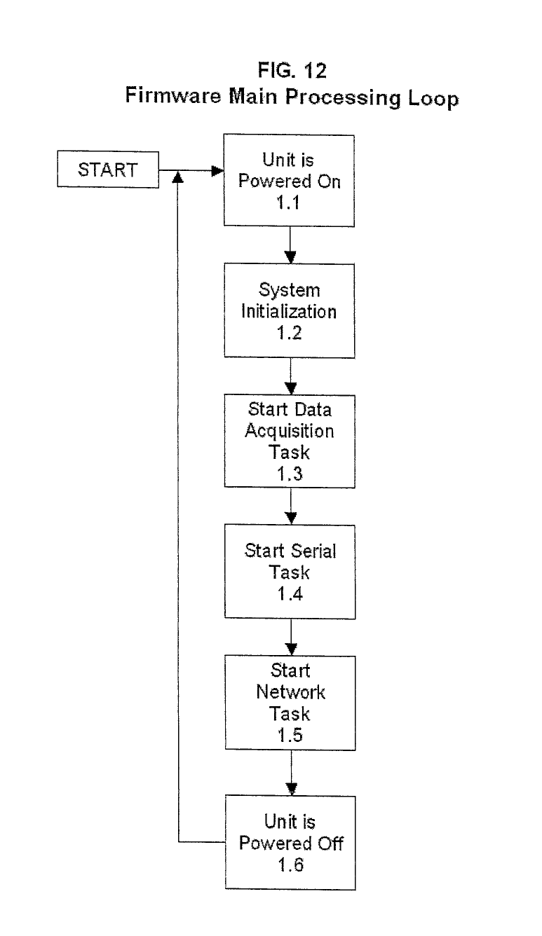

FIG. 12 shows a preferred embodiment of a firmware processing loop of a DC&CT unit 11. In step 1.1, the unit is powered on. During the step “system initialization 1.2” system variables may be initialized, a real time clock function may be started and/or the accuracy of the configuration data that was stored in system memory may be verified. Starting the data acquisition 1.3, serial 1.4 and network 1.5 tasks that follow system initialization are described in more detail below. In a preferred embodiment, a micro-c real time operating system in the microprocessor the DC&CT unit 11 affords control over the processing time between those tasks. In a preferred embodiment, when DC&CT unit 11 reaches “unit is powered off 1.6” at the bottom of the diagram, a battery will, in a preferred embodiment, continue to supply power to the system memory, allowing e.g. system configuration and meter usage data to remain in the DC&CT unit 11's memory, such as during a power outage. In a preferred embodiment, usage data retained in the memory may be sent to a CCT&DG unit after the power outage.

Data Acquisition Task

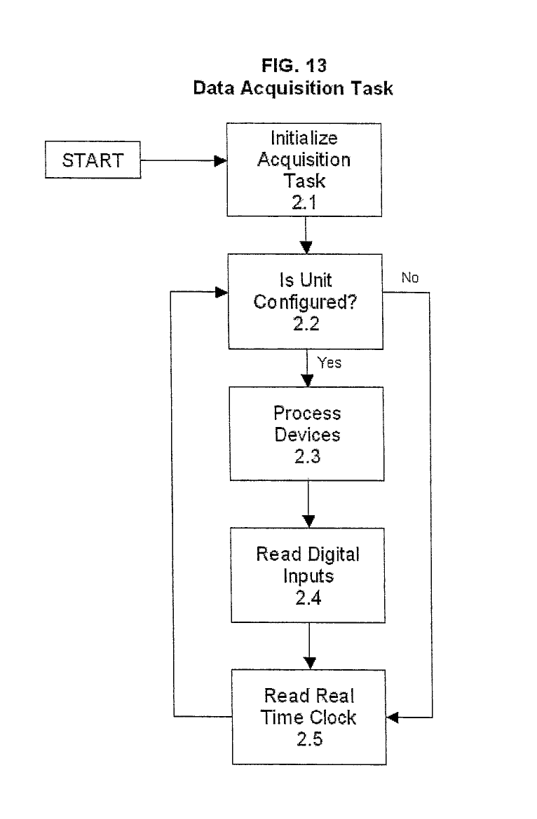

FIG. 13 is a flow diagram of a preferred embodiment of a data acquisition task. During the data acquisition task, in a preferred embodiment, digital inputs of a DC&CT unit 11, such as the optically isolated digital inputs 23 in FIG. 3, are read and, in another preferred embodiment, the data received via such inputs is processed.

In a preferred embodiment variables used to control the data flow throughout the “data acquisition task,” and, in another preferred embodiment, digital inputs, are initialized as indicated in the figure by “initialize data acquisition task 2.1.” In another preferred embodiment, real time operating system functions which provide watchdog functions to help to prevent the DC&CT unit 11 from entering an improper state will be initialized during this step. As indicated by “is unit configured? 2.2,” in a preferred embodiment, a determination will be made whether the DC&CT unit 11 is configured appropriately. In a preferred embodiment, the state of the unit configuration was initially determined during the step “system initialization 1.2” shown in FIG. 12.

“Process devices 2.3” in FIG. 13 refers to a step in which data received via digital inputs is processed. In a preferred embodiment, after e.g. a minute has expired on e.g. an internal real time clock of the DC&CT unit 11, data received from utility consuming devices that are in an active state, as determined by the system configuration, will be processed, that means, the utility consumption of one or more devices for the previous minute is calculated. In a preferred embodiment, the calculated consumption data is stored in a log that holds the minute usage for e.g. the last one hundred and twenty minutes. In another preferred embodiment, rolling interval calculations, such as minute to minute calculations of data received e.g. in the previous five, ten, and fifteen minutes can be preformed.

In another preferred embodiment, time intervals are set and consumption during each interval will be calculated successively without overlaps. After such a time interval has expired for the given device, the interval data is calculated and stored. In such an embodiment, the intervals can range e.g. from ten to sixty minutes. In a preferred embodiment, thirty days worth of interval data can be stored for each device.

In another preferred embodiment, a system flag that indicates that data is ready for transfer can be toggled on e.g. in DC&CT units 11 that transmit data without request from e.g. the CCT&DG unit 12. In DC&CT units 11 which transmit data only upon request, the system flag can be ignored. Processing of data received from the digital inputs follows reading of an input for each of the configured and active digital devices. In a preferred embodiment data is stored for each device and will be processed as described for the step “process devices 2.3.” In a preferred embodiment, a real time clock is provided (“read real time clock 2.5”) via which the times for data processing can be determined. The “process devices 2.3” step can also be performed in devices that receive data via other than via a digital input.

Serial Task

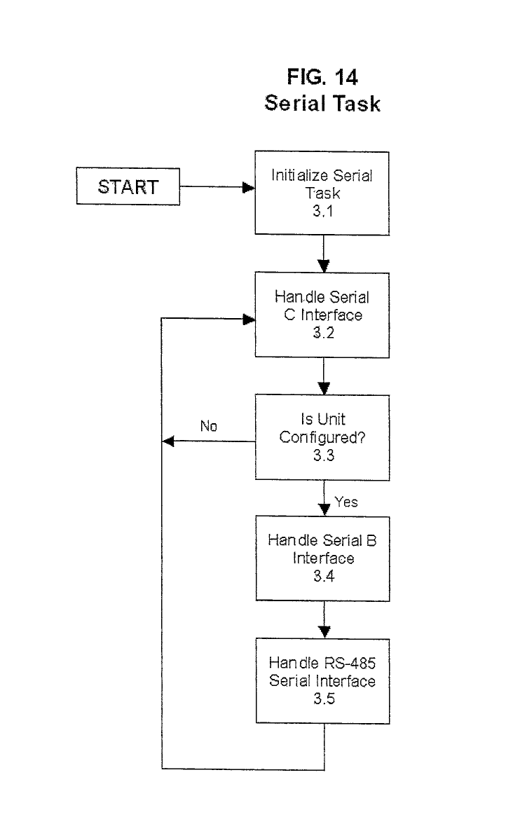

FIG. 14 is a flow diagram of a preferred embodiment of the serial task. During the serial task, in a preferred embodiment, serial inputs of a DC&CT unit 11, such as the input/output ports 24 in FIG. 3, are read. In a preferred embodiment the serial task also processes the data received via such inputs. In a preferred embodiment, during initialization of the serial task variables used to control the data flow throughout the serial task are initialized. In another preferred embodiment real time operating system functions that provide watchdog functions to help prevent the unit from entering an improper state will also be initialized. In yet another preferred embodiment data is sent over serial input C causing an operator menu to appear on a menu driven interface such as a hyperterminal.

“Serial interface C” can, in a preferred embodiment, be used as a configuration and/or debugging port for operators. In a preferred embodiment input from serial C will give an operator one or more of the options described in more detail below. Other options might be available in addition or alternatively to the options listed below, such as options to set a unit identification or to set other communication parameters. All or some of the options listed might be omitted from a particular DC&CT unit 11, while others may be added.

Network Configuration

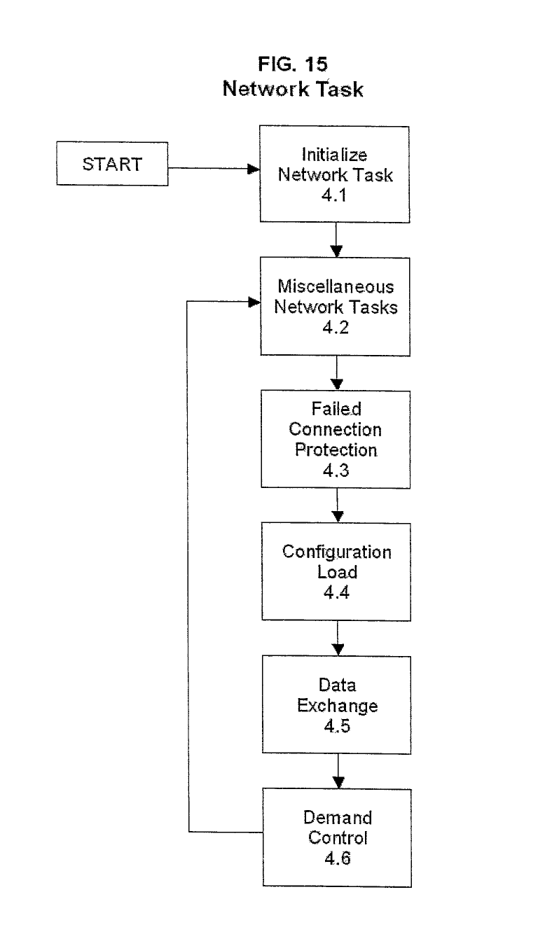

This option allows the network to be reconfigured by the operator. In a preferred embodiment, checks are put in place to ensure that the data entered by the operator, such as a network address, is valid. If the network is reconfigured, it will be reinitialized during the step “miscellaneous network tasks 4.2” of FIG. 15.

Server Ping

This option allows the operator to request the DC&CT unit 11 to ping the configured server. In a preferred embodiment, a flag may be set indicating that a ping has been requested. The actual ping occurs during the step “miscellaneous network tasks 4.2” in FIG. 15.

Configuration Reload

This option allows the operator to request the system to reload its configuration from the server of CCT&DG unit 12. A flag will be set indicating that a configuration reload has been requested. The actual configuration reload occurs during the step “configuration reload 4.4.” in FIG. 15.

Unit Reset

This option allows the unit to be reset. Thus, in a preferred embodiment, this option allows all stored data to be erased. When this option is selected all tasks may cease running and the system will return to “system initialization 1.2” in FIG. 12.

Unit Counter Display

This option will cause the system to send commands over serial interface C to display the consumption values for all configured meters e.g. on a menu driven interface such as a hyperterminal for the operator's view.

KV (Electronic) Test

This option allows a test to be performed on at least one electronic meter such as a KV meter.

Unit Restart

This option causes all programming flows to cease. In a preferred embodiment, the DC&CT unit 11 will return to “System Initialization 1.2” In FIG. 12. However, in a preferred embodiment, all stored data will continue to exist.

In a preferred embodiment the DC&CT unit 11 will proceed only through the “Serial C Interface” operations described above if, e.g., an operator's computer is connected to the Serial C Interface. Thus, either directly after the step designated “Initialization of the Serial Task 3.1” or after the step designated as “Handle Serial Interface C 3.2,” the DC&CT unit 11 may, in a preferred embodiment, determine whether it is configured appropriately as indicated by “Is Unit Configured 3.3?” The state of the unit configuration is initially determined during “System initialization 1.2” in FIG. 12. Subsequently, in the step designated “Handle Serial B Interface 3.4,” an active electronic meter may, in a preferred embodiment, be configured to be read, and any input that is available on serial interface B will be read and processed as described under FIG. 13. See in particular “Process Devices 2.3”.

In another preferred embodiment, if an active electronic meter is configured on the RS485 serial port, then any available input will be read and processed as described with FIG. 13. See in particular “Process Devices 2.3”. In a preferred embodiment, in DC&CT units 11 that do not have serial ports, the respective reading and processing functions may be omitted.

Network Task

FIG. 15 shows a flow diagram of a preferred embodiment of a network task. During a network task, in a preferred embodiment, a network initializes and maintains the network and handles communications with the CCT&DG unit 12. In a preferred embodiment, messages that are transferred between a DC&CT unit 11 and a CCT&DG unit 12 contain version information. Version information allows older DC& CT units 11 to communicate with newer CCT&DG units 12 and vice versa. In a preferred embodiment messages that are transferred between the DC&CT Unit 11 and the CCT&DG Units 12 contain an HTTP header, which allows the data to pass through most firewalls.

In a further preferred embodiment safety checks are implemented throughout the data exchange process to ensure that neither side of the interface is left in an unknown state, and that all information is exchanged accurately. In a preferred embodiment during the step designated “Initialize Network Task 4.1,” variables which are used to control the data flow throughout the network task are initialized. In another preferred embodiment, the TCP/IP functions are initialized. If appropriate, an error flag may be set indicating that the configuration should be reloaded. In another embodiment, real time operation system functions that provide watchdog functions to help to prevent the DC&CT units 11 from entering an improper state are also initialized.

In a preferred embodiment during the step designated “Miscellaneous Network Tasks 4.2” the DC&CT unit 11 checks for a system flag indicating whether the network has been reconfigured and will, if reconfiguration has occurred, reinitialize the TCP/IP functions. In this step the DC&CT unit 11, in a preferred embodiment, checks for a system flag indicating whether the operator has asked for the unit to ping the server as e.g. described under “sever ping” under FIG. 14 and will, if this flag is set, in a preferred embodiment, send a network ping to the server. The DC&CT unit 11 has, in a preferred embodiment, a protection mechanism against failed connection attempts as indicated by “Failed Connection Protection 4.3” in FIG. 15. In such an embodiment, the DC&CT unit 11 has a system variable that counts the number of sequential failed connection attempts. In a preferred embodiment, two prevention steps are provided in the unit to assure that the DC&CT unit 11 stays connected to the CCT&DG unit 12. In a preferred embodiment, the first prevention step activates when the number of failed connection attempts reaches ten. In this embodiment, the DC&CT unit 11 will reload its network configuration e.g. from flash storage and then may reinitialize the TCP/IP functions. Preferably, the DC&CT unit 11 will set a flag indicating that the configuration should be reloaded. If, in a preferred embodiment, the number of sequential failed connection attempts continues to increase and becomes greater than twenty, the address of the backup server of the CCT&DG unit 12 will replace the address of the primary server in the DC&CT unit's 11 memory during a second prevention step. In a preferred embodiment, the TCP/IP functions will be reinitialized, and a flag indicating that the configuration should be reloaded may be set. At this point the number of sequential failed connection attempts is, in a preferred embodiment, set to zero. This allows the failed connection protection described herein to be reactivated now that the backup server has replaced the primary server. As indicated by “configuration load 4.4,” if a flag has been set indicating that the DC&CT unit's 11 configuration needs to be reloaded, and, in a preferred embodiment, if a set time interval such as a minute has expired since the last time that the DC&CT unit 11 requested a configuration reload from the CCT&DG unit 12, then the DC&CT unit 11 will send a configuration reload request to the CCT&DG unit 12. If the message is not successfully transmitted to the CCT&DG unit 12, the configuration reload flag will still be set, and processing flow will move to 4.5 data exchange. After the message is sent to the server, the DC&CT unit 11 will wait for a reply message. In a preferred embodiment, if a reply is not received, the configuration reload flag will still be set, and processing flow will move to “data exchange 4.5”. In a preferred embodiment, if a reply is successfully received, the updated configuration will be processed. During the configuration processing, in a preferred embodiment, the real time clock will be synchronized with clock of the CCT&DG unit 12 and device data will be updated. In another preferred embodiment, if the network is not configured, the process will flow to 4.6 load management. In another preferred embodiment, if the network is configured and e.g. a system flag that indicates that data is ready to be sent to the CCT&DG unit 12 is toggled on, data transfer will occur. The same data message will be sent to each active server address that is configured for the respective DC&CT unit 11.

A data message that is sent from the DC&CT unit 11 to the server of the CCT&DG unit 12 may, in a preferred embodiment provide information such as status information, and updated usage data of the respective DC&CT unit 11. In another preferred embodiment, the DC&CT unit 11 may also send the CCT&DG unit 12 various messages e.g. in the form of addendums that contain information that was requested by the server. In a preferred embodiment, at least one of the addendums supported by the DC&CT unit 11 take the form of an (1) instant observation transmission, in which the DC&CT unit 11, if the appropriate system flag is set, will retransmit e.g. up to one hundred and twenty minutes of current usage data; (2) interval observation transmission, in which the DC&CT unit 11, if the appropriate system flag is set, will retransmit up to thirty one days of interval usage data and/or (3) power quality observation transmission, in which the DC&CT unit 11, if the appropriate system flag is set, will retransmit up to one hundred and twenty minutes of power quality observation data. In a preferred embodiment, if the server did not receive the message and/or any addendums successfully, the process will continue to 4.2 miscellaneous network tasks. Similarly, in a preferred embodiment, if the unit does not successfully receive a reply message from the server, process flow will continue to 4.2 miscellaneous network tasks. In a preferred embodiment, if the DC&CT unit 11 does successfully receive a reply message from the CCT&DG unit 12, the message and any addendums will be processed. The message from the CCT&DG unit 12 may, in a preferred embodiment contain a flag that may require the DC&CT unit 11 to request a configuration download from the server of the CCT&DG unit 12 again. This flag would be set if any of the DC&CT units 11 configuration information located on the server of the CCT&DG unit 12 had been updated since the last time the DC&CT units 11 configuration was downloaded. The actual configuration download will be done in the step designated “configuration download 4.4”. In a preferred embodiment, the message may also contain a number of addendums that cause various system flags to be set. The addendums include, but are not limited to, (1) instant observation requests, in which the appropriate system flag will be set that will cause the DC&CT unit 11 to retransmit a certain number of observations that the server is missing. The actual data will be transmitted in the step (1) “instant observation transmission” discussed above; (2) interval observation requests, in which the appropriate system flag will be set that will cause the DC&CT units 11 to retransmit a certain number of interval observations that the server is missing. The actual data will be transmitted in (2) “interval observation transmission” discussed above and/or (3) “power quality observation requests” in which the appropriate system flag will be set that will cause the DC&CT unit 11 to retransmit a certain number of power quality observations that the server is missing. The actual data will be transmitted in (3) “power quality observation transmission” discussed above. In a preferred embodiment, if a set time interval, e.g. a minute has not expired since the last time the demand control function was performed, process will go back to the step “miscellaneous network tasks 4.2”. In another preferred embodiment, if a set time interval, e.g., one minute has expired since the last time the demand control function was performed, the DC&CT units 11 may, in a preferred embodiment, use locally stored demand control rules and, optionally, information of the current state of each utility consuming device to determine and perform the appropriate demand control action. DC&CT units 11 that are not directly associated with a network do, in a preferred embodiment, not have a network task. Instead, those units, may, in a preferred embodiment, have a communication task, that sends or receives e.g. cable or radio frequency messages and, in a more preferred embodiment, also performs appropriate processing and demand control functions.

The foregoing has described a particular embodiment of the invention. It will be understood by those skilled in the art that modifications or alternative embodiments may be effected without departing from the spirit of the concepts of this invention. The scope of the invention is further defined by the appended claims.

Table 1 contains a non-exhaustive list of examples of hardware and software components for the various types of demand control and consumption tracking units as well as the centralized command transmission and data gathering unit.

Table 1.

Demand Control and Consumption Tracking Unit

Rabbit Semiconductor Rabbit 2000 Microprocessor (includes memory, real time clock, and MicroC operating system)

Software written in Rabbit Semiconductor Dynamic C

RealTek RTL8019AS—Ethernet controller Maxim MAX483—RS-485 transceiver

Maxim MAX232ACPE—RS-232 Driver/Receiver

NEC PS2532—optically isolated digital inputs

SAMSUNG KM684000CLG-7L—Memory, static RAM

Panasonic CR2330—Battery

SIEMENS T7CS5D-12—Control relays

Wireless and Cable Units

Rabbit Semiconductor Rabbit 2000 Microprocessor (includes memory, real time clock, and MicroC operating system)

Software written in Rabbit Semiconductor Dynamic C

SAMSUNG KM684000CLG-7L—Memory, static RAM

HYUNDAI HV628400A—Memory

MXCOM MX429AP—MSK modem

MAXIM MAX232ACPE—RS-232 Driver/Receiver

MAXIM MAX483—RS-485 transceiver

SIEMENS T7CS5D-12—Control relays

NEC PS2532—optically isolated digital inputs

Panasonic CR2330—Battery

Base Unit

Rabbit Semiconductor Rabbit 2000 Microprocessor (includes memory, real time clock, and MicroC operating system)

Software written in Rabbit Semiconductor Dynamic C

SAMSUNG KM684000CLG-7L—Memory, static RAM

HYUNDAI HV628400A—Memory

MXCOM MX429AP—MSK modem

MAXIM MAX232ACPE—RS-232 Driver/Receiver

RealTek RTL8019AS—Ethernet controller

Centralized Command Transmission and Data Gathering Unit

Dell PowerApp 120, running Windows 2000

512 MB RAM

1 GHz processor

72 GB disk space

Ethernet network card

Sun Microsystems'Java v1.3 runtime environment

Software written in Java (v1.3)

### DEFINITIONS

Bridge:

A bridge is a product that connects a local area network (LAN) to another local area network that uses the same protocol (for example, Ethernet or token ring). You can envision a bridge as comprising hardware and/or software that decides whether a message from you to someone else is going to the local area network in your building or to someone on a local area network in the building across the street. A bridge examines each message on a LAN, “passing” those known to be within the same LAN, and forwarding those known to be on the other interconnected LAN (or LANs).

In bridging networks, computer or node addresses have no specific relationship to location. For this reason, messages are sent out to every address on the network and accepted only by the intended destination node. Bridges learn which addresses are on which network and develop a learning table so that subsequent messages can be forwarded to the right network.

Bridging networks are generally always interconnected local area networks since broadcasting every message to all possible destinations would flood a larger network with unnecessary traffic. For this reason, router networks such as the Internet use a scheme that assigns addresses to nodes so that a message or packet can be forwarded only in one general direction rather than forwarded in all directions.

A bridge works at the data-link (physical network) level of a network, copying a data frame from one network to the next network along the communications path.

A bridge is sometimes combined with a router in a product called a brouter.

Centralized:

Refers to a given unit having communications with a greater number of other units, for example a centralized command transmission and/or data gathering unit that has communications with a plurality of utility demand control and/or consumption tracking units. Centralized does not require that the given unit have a central geographic location with respect to the other units. Nor does it exclude the possibility that there may be still other units that are centralized with respect to a group of given units.

Command:

“Command” is used in a broad sense to include any transmission in any format (including any protocol) able to directly or indirectly trigger operation of a demand control unit, for example via PLC signals, one or more tones transmitted over a telephone network, radio signals, digital turn down or turn off commands and digital rule sets to be applied by a computer at the consumption domain, whether sent over a computer information network, such as the Internet or an intranet, or another type of communication medium. A command may for example be a transmission calling for a specific action, which may require immediate or delayed action, or may be a rule set, which may comprise one or more rules, e.g., “if-then” statements, to be interpreted and applied by a unit, system or component of either which has received the rule set.

Computer Information Network:

A set of plural computer networks that are connected through bridges, or switches or routers, or any combination of these, and in which data is forwarded, with or without previously established connections, in packets or cells, according to any suitable present or future protocol, for example at least one of TCP/IP, X.25, Frame Relay and ATM (Asynchronous Transfer Mode). Preferably, the computer information network is the Internet (world wide web) as it exists now and in future improved or simplified forms, and other related systems.

From the standpoint of data integrity, TCP/IP, X.25 and ATM are preferred when networks are operating near design capacity. If Frame Relay is used, it is recommended to run an upper layer protocol above Frame Relay that is capable of recovering from errors, such as TCP/IP, IPX or HDLC. Other useful protocols are currently listed and described in a website identified as Protocols.com, sponsored by Radcom Academy.

These bridge-, switch- and/or router-based multiple-network computer information networks should be distinguished from telephone systems, including telephone switched networks. In a computer information network it is not necessary to engage in switching action in a telephone system switch for a network in the computer information network to communicate with another such network.

However, telephone systems, or at least parts of them, may be employed to connect together some components of systems or units according to the invention. One example is the connection of utility meters to a utility demand control and/or consumption tracking unit across telephone wiring in a home. Another example is use of leased telephone lines to transport communications between the networks of computer information networks. In some instances, parts of systems according to the invention may gain access to computer information networks over telephone systems. Preferably, access is gained without dial-up.

Computer System:

The term includes any programmable device that comprises a CPU (central processor unit), an input device, an output device and memory, which usually also includes a storage device and a bus and may also include a communications means. The communications means may for example be a modem or an EtherNet port. The computer system may also be part of a combination of computers, such as a network of the EtherNet, token-passing ring or other type.

Configured:

Arranged in a way, such as by means of hardware and/or software (including firmware), to operate in an indicated manner.

Consumption Data:

Data which quantifies or otherwise characterizes use of a utility. Examples include an amount of kilowatt hours of electricity used, cubic feet of fuel gas used, or gallons of water used. Data characterizing the use of utilities may for example include information about the time at which a consumption reading is taken, amounts used during particular time periods, whether a particular utility consuming system is turned on, turned off or turned down, and any other data useful in conjunction with quantity data.

Where demand control includes switching on a standby generator for a period of time to generate at least a portion of the power required by an electricity consuming system, the consumption data may for example include a representation of the total electricity consumed or of the net of the total electricity consumed and of the amount which is generated by the standby generator.

Demand Control:

Any method of controlling mode of consumption of a utility by a utility consuming system, for example: or by interrupting, reducing or partly or fully restoring the flow of the utility; by turning down, turning off or partly or fully restoring operation of the system; or by otherwise controlling the utility consumption pattern of the system. Pattern controls may for example include limiting or altering the time periods during which the utility flows, or limiting or altering the rates at which the utility flows during particular time periods.

Demand control may also include causing one or more utility consuming systems to switch from one utility source to another, for example, causing electricity consuming systems in one or more domains to switch to a different vendor or start up their own standby generators to produce part or all of their electricity requirements. Demand control can for example be exercised in the form of specific commands from a remote station to a local station to cause a utility consuming system to alter its mode of operation in a particular way. Or demand control may be exercised on the basis of rule sets transmitted by the remote station to the local station, which stores the rule sets, interprets the stored rules and alters the operating mode of the utility consuming system from time to time according to the rules. These rule sets may be altered or replaced from time to time by further transmissions from the remote station.

Domain:

A “domain” is an area or group of areas in which a utility is consumed.

Firewall:

Any security system (including hardware and/or software) capable of guarding a computer system, which may include a network, against unauthorized entities gaining access to the computer system from outside that system. Such security system may for example involve a packet filter, an application gateway, a circuit-level gateway, a proxy server, any other form of security system performing these and/or other functions, a plurality of any one of the foregoing, and any combination of these. A security system may optionally be used in conjunction with encryption of data, data headers or other portions of transmissions between a computer system and other computer systems.

Flow:

Refers to the flow of any utility, regardless of its physical form. Thus, for example, a flow may be a flow of electricity, or of a gas or liquid.

Interconnected:

Having a cooperative relationship. Interconnection may involve a physical connection (e.g., by wires or operating linkage) or non-physical (e.g., by radio or infra-red light waves). Such connections may be continuous or may only exist from time to time as required to carry out one or more desired operation(s).

Line(s):

Refers to an elongated conveyance for conducting a flow of a utility from one location to another, such a wire for electricity or a conduit for a gas or a liquid.

Real Time:

A real time system is one which is able to respond in a timely, predictable way to unpredictable external stimuli. More particularly, a real time system has to fulfil, under extreme load conditions, requirements of: (a) timeliness: the system must meet deadlines, and must therefore finish assigned tasks within whatever time boundaries it is required to respect; (b) simultaneity or simultaneous processing: even if two or more events happen simultaneously, all deadlines should be met; (c) predictability: the real time system has to react to all possible events in a predictable way; and (d) dependability or trustworthiness: it is necessary that the real time system environment can rely on it.

In the context of the present invention, and particularly in systems involving demand control, the frequency of sampling of consumption data by utility demand control and/or consumption tracking units and the frequency of communication of that data any centralized command transmission and/or data gathering units will be important factors in determining whether these systems can effect timely, predictable and dependable demand control. Sampling and communication should be sufficiently frequent, in relation to the level of consumption then occurring and to the response time of all elements of the system, so that the system will exercise effective demand control.

More particularly, sampling and communication should be frequent enough so that the system can provide timely, predictable and dependable demand control, notwithstanding multiple and conflicting stimuli that may be exerted on the system. Thus, in the case of controlling demand for electricity or fuel gas, the system should for example be capable of coping with unexpected changes in ambient air temperature and wind velocity, which may affect the system in additive or off-setting ways.

Wide variations are possible in such factors as, for example, the processing speeds of the computers involved in the systems, the data transfer rates of different communications media that may be involved in the systems, differences in the rate of change of climatic conditions in different geographical areas, the numbers of utility consuming devices under control in a given system and how close to capacity the utility supply system under the control of the system may be operating at a given time. Because of the varying nature of these factors, it is not possible to specify a fixed or absolute interval of sampling and transmission frequency that represents real-time operation in the context of the invention. However, it is anticipated that in some applications of the invention, sampling and transmission intervals may be as small as about one minute, and that under other circumstances longer intervals will be sufficient to satisfy the above criteria.

Remote:

Refers to a unit, a system or a component of either being at a distance from, i.e., “distanced from”, another unit, system or component. No fixed distance exists that is applicable to all embodiments of the invention. For purposes of the present invention, the distance interval is one that will be chosen by one skilled in the art in the process of system, unit or component design. One of the factors that will bear on this choice are how far apart it is desired to locate units, systems and/or components that must communicate with one another.

For example, where a demand control and consumption tracking unit will receive data from several nearby utility consuming systems, that unit and the respective systems it serves would be considered remote from one another even if there were only a few feet between them. The distance involved could be as small as about 2 or more, about 5 or more, about 10 or more or about 25 or more feet. In this context, the distance interval is similar to that involved in the use of “remote” in reference to a common TV remote control.

On the other hand, consider the example of a base station. In some embodiments, a base station may represent a remote centralized command transmission and data gathering unit for a plurality of local demand control and data gathering units. These local units may for example be located at individual homes in a neighborhood with relatively small lots or at widely spaced individual buildings on a university campus. In such applications and others the base station would be considered remote from the local units even if the base station and local units were distanced from one another by as little as about 50 or more, or about 100 or more or about 1,000 or more feet.

However, this same base station may represent a local demand control and data gathering unit in its relationship with a remote centralized command transmission and data gathering unit with which the base station also communicates. There may be considerable variation in the size of the geographical area over which it is desired that the remote unit will control demand and gather data via the base station and perhaps others like it. Variation in the size of this area will in turn affect the distance selected to exist between the remote unit and the base station(s). In this context, remote may include distances of about a half mile or more, or about a mile or more, and distances of many miles.

Router:

A router comprises hardware and/or software that can determine the route and specifically what adjacent network point data should be sent to.

Switch:

A switch is a network device, which may include hardware and/or software, that selects a path or circuit for sending a unit of data to its next destination. In general, a switch is a simpler and faster mechanism than a router, which requires knowledge about the network and how to determine the route. However, in some instances a switch may also include one or more of the functions of a router.

System:

Synonymous with unit.

Unit:

A “unit” is one or more components that cooperate to perform one or more indicated types, and possibly other types, of operation(s). Where a unit includes more than one component, the components may for example be combined in the sense of being located together, for example on the same circuit board or in a common housing, or they may be located at different places, i.e., separated, while being interconnected physically (e.g., by wires or operating linkage) or non-physically (e.g., by radio or infra-red light waves) to perform the operation(s). Also, different kinds of units may be combined or separated in the above-described manner.

1. A method of communication useful in remote utility demand control systems, automated utility data gathering systems and combined utility demand control and data systems, comprising:
a. providing a plurality of utility demand control and/or consumption tracking units having communications means, said units being operationally associated with at least one utility consuming system located in at least a portion of a utility consumption domain;
b. providing at least one centralized command transmission and/or data gathering unit distanced from at least a portion of said demand control and/or consumption tracking units;
c. causing the communications means of the demand control and/or consumption tracking units to have recurring communications with the at least one centralized command transmission and/or data gathering unit via one or more communications media, including at least one computer information network; and
d. during at least a portion of said communications, establishing connections between, and causing two-way communications to occur between, the communications means and the at least one centralized command transmission and/or data gathering unit.

2. A method of communication useful in remote utility demand control systems, automated utility data gathering systems and combined utility demand control and data systems, comprising:
a. providing a plurality of utility demand control and/or consumption tracking units having communications means, said units being operationally associated with at least one utility consuming system located in at least a portion of a utility consumption domain;
b. providing at least one centralized command transmission and/or data gathering unit distanced from at least a portion of said demand control and/or consumption tracking units;
c. causing the communications means of the demand control and/or consumption tracking units to have recurring communications with the at least one centralized command transmission and/or data gathering unit via one or more communications media, including at least one computer information network; and
d. during at least a portion of said communications, causing transmission of consumption data through the communications means to the at least one centralized command transmission and/or data gathering unit to commence uncommanded by said data gathering and/or command transmission units.

3. A method according to claim 1 or 2 wherein a plurality of said utility demand control units and at least one centralized command transmission unit are provided.

4. A method according to claim 1 or 2 wherein a plurality of said utility consumption tracking units and at least one centralized data gathering unit are provided.

5. A method according to claim 1 or 2 wherein a plurality of said utility demand control and consumption tracking units and at least one centralized command transmission and data gathering unit are provided.

6. A method according to claim 1 or 2 wherein there are utility demand control and consumption tracking units that comprise separate but interconnected components that respectively perform demand control and/or consumption tracking functions.

7. A method according to claim 1 or 2 wherein the at least one centralized command transmission and data gathering unit comprises separate but interconnected components that respectively perform command transmission and/or data gathering functions.

8. A method according to claim 1 or 2 wherein at least one of said utility demand control and consumption tracking units is a multi-stage unit comprising autility demand control and/or consumption tracking first stage station and a plurality of utility demand control and/or consumption tracking second stage stations respectively interconnected with the first stage station, and wherein the first stage station
a. receives demand control first commands from the at least one centralized command transmission and/or data gathering unit and transmits demand control second commands to at least a portion of the second stage stations, said second commands being identical to or at least in conformity with said first commands, and/or
b. receives utility consumption first data from at least a portion of the second stage stations and transmits utility consumption second data to the at least one centralized command transmission and/or data gathering unit, said second data
i. being identical to the first data, or
ii. incorporating at least a portion of the first data, or
iii. representing a compilation of the first data, or
iv. being in conformity with said first data.

9. A method according to claim 8 wherein a plurality of said utility demand control and consumption tracking units are multi-stage units respectively comprising a utility demand control and/or consumption tracking first stage station and a plurality of utility demand control and/or consumption tracking second stage stations.

10. A method according to claim 8 wherein transmissions pass between the first stage stations and the at least one centralized command transmission and/or data gathering unit via said computer information network and transmissions pass between the first and second stations via a different communications medium.

11. A method according to claim 10 wherein the different communications medium is at least one member selected from the group consisting of electricity supply wiring serving at least a portion of a domain, optical fiber cable, coaxial wire cable, other dedicated wiring, telephone wires, atmospheric infra-red light signals, radio signals, a local area computer network serving at least a portion of a domain, an E-mail system and a cable TV system.

12. A method according to claim 1 or 2 wherein said one or more communications media includes, in addition to said computer information network, at least one member selected from the group consisting of electricity supply wiring serving at least a portion of a domain, optical fiber cable, coaxial wire cable, other dedicated wiring, telephone wires, atmospheric infra-red light signals, radio signals, a local area computer network serving at least a portion of a domain, an E-mail system and a cable TV system.

13. A method according to claim 1 or 2 wherein at least a portion of said communications is/are connectionless.

14. A method according to claim 1 or 2 wherein said communications include transmissions across said network which are connectionless and transmissions via connections on said network.

15. A method according to claim 1 or 2 wherein said communication is at least in part according to at least one TCP/IP protocol.

16. A method according to claim 1 or 2 wherein said communication is at least in part according to at least one connection-oriented protocol.

17. A method according to claim 16 wherein said communication is at least in part according to at least one HTTP protocol.

18. A method according to claim 16 wherein said communication is at least in part according to at least one TCP protocol.

19. A method according to claim 1 or 2 wherein said communication is at least in part according to at least one E-mail protocol.

20. A method according to claim 1 or 2 wherein at least a portion of the transmissions from the local subsystems to the at least one remote subsystem continue to progress without interruption until reaching the at least one remote subsystem.

21. A method according to claim 1 or 2 wherein at least a portion of the communications between the local subsystems and the at least one remote subsystem pass through a communications relay.

22. A method according to claim 1 or 2 wherein the operational association of demand control units with utility consuming systems is, at least in part, through control relays and/or solenoid valves controlling the flow of one or more utilities through utility supply lines serving the utility consuming systems.

23. A method according to claim 1 or 2 wherein the operational association of demand control units with utility consuming systems is, at least in part, through control relays controlling the flow of utilities through utility supply lines serving the utility consuming systems, and wherein the relays are located at the demand control units.

24. A method according to claim 1 or 2 wherein the operational association of consumption tracking units with utility consuming systems is, at least in part, through sensors that determine the flow of one or more utilities flowing in utility supply lines serving one or more utility consuming systems in the respective domains.

25. A method according to claim 1 or 2 wherein the operational association of consumption tracking units with utility consuming systems is, at least in part, through utility flow meters and meter-reading sensors on utility supply lines serving the respective domains.

26. A method according to claim 1 or 2 wherein the operational association of consumption tracking units with utility consuming systems is, at least in part, through utility flow meters and meter-reading sensors on utility supply lines that supply at least two different kinds of utilities in each of a plurality of the domains.

27. A method according to claim 1 or 2 wherein the operational association of consumption tracking units with utility consuming systems is, at least in part, through utility flow meters and meter-reading sensors on utility supply lines serving the respective utility consuming systems.

28. A method according to claim 1 or 2 wherein the operational association of consumption tracking units with utility consuming systems is, at least in part, through utility flow meters and meter-reading sensors on utility supply lines that supply one or more different kinds of utilities to at least two utility consuming systems in each of a plurality of domains.

29. A method according to claim 1 or 2 wherein the at least one computer information network is the internet.

30. A method according to claim 1 or 2 wherein the at least one computer information network is an extranet.

31. A method according to claim 1 or 2 wherein the utility demand control and/or consumption tracking units represent local subsystems and at least one of these local subsystems is on an intranet serving at least a portion of a domain.

32. A method according to claim 1 or 2 wherein the utility demand control and/or consumption tracking units represent local subsystems and at least one of these local subsystems is on a local area network serving at least a portion of a domain.

33. A method according to claim 1 or 2 wherein the utility demand control and/or consumption tracking units are components of a building energy management system.

34. A method according to claim 1 or 2 wherein the utility demand control and/or consumption tracking units represent local subsystems and the at least one centralized command transmission and/or data gathering unit represents at least one remote subsystem, and the local subsystem comprises a computer system which participates in demand control and/or consumption tracking functions and which includes a communications firewall.

35. A method according to claim 34 wherein the computer system is included in a local area network which is guarded by the communications firewall.

36. A method according to claim 34 wherein the firewall is configured to operate in at least one mode selected from the group consisting of packet filtering, application gateway, circuit-level gateway and proxy server.

37. A method according to claim 34 wherein the firewall is configured to bar initiation by the remote subsystem of connections to the communications means of the local subsystems.

38. A method according to claim 34 wherein recurring communications of the demand control and/or consumption tracking units of the local subsystems with the at least one centralized command transmission and/or data gathering unit of the remote subsystem are initiated by the local subsystems.

39. A method according to claim 34 wherein transmissions from the remote subsystem to the local subsystems occur during connections between the remote subsystem and the local subsystems initiated by the local subsystems from behind the firewall.

40. A method according to claim 34 wherein transmissions from the remote subsystem to the local subsystems occur only during connections between the remote subsystem and the local subsystems initiated by the local subsystems from behind the firewall.

41. A method according to claim 34 wherein transmission of demand control commands from the at least one remote subsystem to the local subsystems occurs only during connections between the remote subsystem and the local subsystems that are initiated by the local subsystems and in which the local subsystems transmit consumption data to the at least one remote subsystem.

42. A method according to claim 1 or 2 wherein recurring communications of the demand control and/or consumption tracking units of the local subsystems with the at least one centralized command transmission and/or data gathering unit of the remote subsystem are initiated by the local subsystems.

43. A method according to claim 1 or 2 wherein transmission of demand control commands from at least one remote subsystem to local subsystems occurs only during connections between the remote subsystem and the local subsystems that are initiated by the local subsystems.

44. A method according to claim 1 or 2 wherein at least one remote subsystem issues demand control commands that comprise instructions to one or more local subsystems to alter the consumption mode of one or more utility consuming systems.

45. A method according to claim 43 wherein the demand control commands comprise specific instructions to alter the operating mode of one or more utility consuming systems in one or more domains.

46. A method according to claim 43 wherein the demand control commands comprise rule sets to be interpreted by the local subsystem to determine when and/or how to alter the operating mode of one or more utility consuming systems in one or more domains.

47. A method according to claim 45 wherein said rule sets are stored by the local subsystems and replaced or amended from time to time by the remote susbsystem.

48. A method according to claim 1 or 2 wherein demand control commands are issued by at least one remote subsystem in response to data received by said at least one remote subsystem from local subsystems.

49. A method according to claim 1 or 2 wherein demand control commands are issued by at least one remote subsystem that are based on data received by said at least one remote subsystem from local subsystems.

50. A method according to claim 1 or 2 wherein demand control commands are issued by at least one remote subsystem that are developed by said at least one remote subsystem based on data received from local subsystems.

51. A method according to claim 1 or 2 wherein at least one remote subsystem issues commands that comprise instructions to one or more local subsystems to report consumption data.

52. A method according to claim 1 or 2 wherein at least one remote subsystem issues commands that comprise instructions to one or more local subsystems to set or change their data transmission times or time intervals.

53. A method according to claim 1 or 2 wherein, during such communications, time data is issued by said at least one remote subsystem to local subsystems for checking and/or reseting clocks within the local subsystems.

54. A method according to claim 2 comprising, during at least a portion of said communications, establishing connections between, and causing two-way communications to occur between, the communications means and the at least one centralized command transmission and/or data gathering unit.

55. A utility remote demand control and/or automated data gathering system comprising a plurality of local subsystems with microprocessors, communications units and software, said local subsystems respectively representing demand control and/or consumption tracking units, said software comprising code that defines at least one common path for two-way transmissions, via at least one computer information network, between the communications units and at least one remote sub-system constituting at least one command transmission and/or data gathering unit.

56. A utility combined control and data system comprising a plurality of local subsystems with microprocessors, communications units and software, said local subsystems respectively representing demand control and consumption tracking units, said software comprising code that defines at least one common path for two-way transmissions, via at least one computer information network, between the communications units and at least one remote sub-system constituting at least one command transmission and data gathering unit.

57. Apparatus according to claim 55 or 56 comprising a plurality of said utility demand control units and at least one centralized command transmission unit.

58. Apparatus according to claim 55 or 56 comprising a plurality of said utility consumption tracking units and at least one centralized data gathering unit.

59. Apparatus according to claim 55 or 56 comprising a plurality of said utility demand control and consumption tracking units and at least one centralized command transmission and data gathering unit.

60. Apparatus according to claim 55 or 56 comprising utility demand control and consumption tracking units that comprise separate but interconnected components that respectively perform demand control and/or consumption tracking functions.

61. Apparatus according to claim 55 or 56 comprising at least one centralized command transmission and data gathering unit which comprises separate but interconnected components that respectively perform command transmission and/or data gathering functions.

62. Apparatus according to claim 55 or 56 wherein at least one of said local subsystems is a multi-stage local subsystem comprising a utility demand control and/or consumption tracking first stage station and a plurality of utility demand control and/or consumption tracking second stage stations respectively interconnected with the first stage station, wherein the local sub-system microprocessors, communications units and software are configured for the first stage station
a. to receive demand control first commands from the at least one centralized command transmission and/or data gathering unit and to transmit demand control second commands to at least a portion of the second stage stations, said second commands being identical to or at least in conformity with said first commands, and/or
b. to receive utility consumption first data from at least a portion of the second stage stations and to transmit utility consumption second data to the at least one centralized command transmission and/or data gathering unit, said second data
i. being identical to the first data, or
ii. incorporating at least a portion of the first data, or
iii. representing a compilation of the first data, or
iv. being in conformity with said first data.

63. Apparatus according to claim 62 wherein a plurality of said utility demand control and consumption tracking units are multi-stage units respectively comprising a utility demand control and/or consumption tracking first stage station and a plurality of utility demand control and/or consumption tracking second stage stations.

64. Apparatus according to claim 62 wherein the local and remote subsystems are configured to pass transmissions between the first stage stations and the at least one centralized command transmission and/or data gathering unit via said computer information network and to pass transmissions between the first and second stations via a different communications medium.

65. Apparatus according to claim 64 wherein the different communications medium is at least one member selected from the group consisting of electricity supply wiring serving at least a portion of a domain, optical fiber cable coaxial wire cable, other dedicated wiring, telephone wires, infra-red light signals, radio signals, a local area computer network serving at least a portion of a domain, an E-mail system and a cable TV system.

66. Apparatus according to claim 55 or 56 wherein the local and remote subsystems are configured to pass transmissions between those subsystems in part via said computer information network and in part via one or more different communications media.

67. Apparatus according to claim 55 or 56 wherein the local and remote subsystems are configured to pass transmissions between the first those subsystems in part via said computer information network and in part via at least one member selected from the group consisting of electricity supply wiring serving at least a portion of a domain, optical fiber cable, coaxial wire cable, other dedicated wiring, telephone wires, atmospheric infra-red signals, radio signals, a local area computer network serving at least a portion of a domain, an E-mail system and a cable TV system.

68. Apparatus according to claim 55 or 56 wherein at least a portion of the local subsystems and/or at least a portion of the remote subsystems is/are configured to permit connectionless transmissions in at least one direction along said path.

69. Apparatus according to claim 55 or 56 wherein at least a portion of the local subsystems and/or at least a portion of the remote subsystems is/are configured to permit connectionless transmissions and transmissions based on connections in at least one direction along said path.

70. Apparatus according to claim 55 or 56 wherein at least a portion of the local subsystems and/or at least a portion of the remote subsystems is/are configured to cause said communication to occur at least in part according to TCP/IP protocol.

71. Apparatus according to claim 55 or 56 wherein at least a portion of the local subsystems and/or at least a portion of the remote subsystems is/are configured to cause said communication to occur at least in part according to a connection-oriented protocol.

72. Apparatus according to claim 71 wherein at least a portion of the local subsystems and/or at least a portion of the remote subsystems is/are configured to cause said communication to occur at least in part according to HTTP protocol.

73. Apparatus according to claim 71 wherein at least a portion of the local subsystems and/or at least a portion of the remote subsystems is/are configured to cause said communication to occur at least in part according to TCP protocol.

74. Apparatus according to claim 55 or 56 wherein at least a portion of the local subsystems and/or at least a portion of the remote subsystems is/are configured to cause said communication to occur at least in part according to E-mail protocol.

75. Apparatus according to claim 55 or 56 wherein at least a portion of the local subsystems and/or at least a portion of the remote subsystems is/are configured to cause at least a portion of the transmissions from the local subsystems to the at least one remote subsystem to continue to progress without interruption until reaching the at least one remote subsystem.

76. Apparatus according to claim 55 or 56 wherein at least a portion of the local subsystems and/or at least a portion of the remote subsystems is/are configured to cause at least a portion of the communications between the local subsystems and the at least one remote subsystem to pass through a communications relay.

77. Apparatus according to claim 55 or 56 wherein there is operational association of demand control units with utility consuming systems which is, at least in part, through control relays and/or solenoid valves that control the flow of one or more utilities through utility supply lines serving the utility consuming systems.

78. Apparatus according to claim 55 or 56 wherein there is operational association of demand control units with utility consuming systems which is, at least in part, through control relays that control the flow of utilities through utility supply lines serving the utility consuming systems, and wherein the relays are located at the demand control units.

79. Apparatus according to claim 55 or 56 wherein there is operational association of consumption tracking units with utility consuming systems which is, at least in part, through sensors that determine the flow of one or more utilities flowing in utility supply lines serving one or more utility consuming systems in domains.

80. Apparatus according to claim 55 or 56 wherein there is operational association of consumption tracking units with utility consuming systems which is, at least in part, through utility flow meters and meter-reading sensors on utility supply lines serving domains.

81. Apparatus according to claim 55 or 56 wherein there is operational association of consumption tracking units with utility consuming systems which is, at least in part, through meters and meter-reading sensors on utility supply lines that supply at least two different kinds of utilities in each of a plurality of domains.

82. Apparatus according to claim 55 or 56 wherein there is operational association of consumption tracking units with utility consuming systems which is, at least in part, through utility flow meters and meter-reading sensors on utility supply lines serving the respective utility consuming systems.

83. Apparatus according to claim 55 or 56 wherein there is operational association of consumption tracking units with utility consuming systems which is, at least in part, through utility flow meters and meter-reading sensors on utility supply lines that supply one or more different kinds of utilities to at least two utility consuming systems in each of a plurality of domains.

84. Apparatus according to claim 55 or 56 wherein the at least one computer information network is the internet.

85. Apparatus according to claim 55 or 56 wherein the at least one computer information network is an extranet.

86. Apparatus according to claim 55 or 56 wherein at least one of the local subsystems is on an intranet serving at least a portion of a domain.

87. Apparatus according to claim 55 or 56 wherein at least one of the local subsystems is on a local area network serving at least a portion of a domain.

88. Apparatus according to claim 55 or 56 wherein the utility demand control and/or consumption tracking units are components of a building energy management system.

89. Apparatus according to claim 55 or 56 wherein one or more of the local subsystems comprise computer systems which participate in demand control and/or consumption tracking functions and which include communication firewalls.

90. Apparatus according to claim 89 wherein the computer system is included in a local area network which is guarded by the communications firewall.

91. Apparatus according to claim 89 wherein the firewall is configured to operate in at least one mode selected from the group consisting of packet filtering, application gateway, circuit-level gateway and proxy server.

92. Apparatus according to claim 89 wherein the firewall is configured to bar initiation by the remote subsystem of connections to the communications means of the local subsystems.

93. Apparatus according to claim 89 wherein the local subsystems and/or the remote subsystem comprise software configured to cause said transmissions to occur during connections initiated by the local subsystems.

94. Apparatus according to claim 89 wherein the local subsystems and/or the remote subsystem comprise software configured to cause transmissions from the remote subsystem to the local subsystems to occur during connections between the remote subsystem and the local subsystems initiated by the local subsystems from behind the firewall.

95. Apparatus according to claim 89 wherein the local subsystems and/or the remote subsystem comprise software configured to cause transmissions from the remote subsystem to the local subsystems to occur only during connections between the remote subsystem and the local subsystems initiated by the local subsystems from behind the firewall.

96. Apparatus according to claim 55 or 56 wherein the local subsystems and/or the remote subsystem comprise software configured to cause transmission of demand control commands from the at least one remote subsystem to the local subsystems to occur only during connections between the remote subsystem and the local subsystems that are initiated by the local subsystems and in which the local subsystems transmit consumption data to the at least one remote subsystem, and wherein the demand control commands represent specific instructions to alter the operating mode(s) of utility consuming systems in one or more domains.

97. Apparatus according to claim 55 or 56 wherein the local subsystems and/or the remote subsystem comprise software configured to cause transmission of demand control commands from the at least one remote subsystem to the local subsystems to occur only during connections between the remote subsystem and the local subsystems that are initiated by the local subsystems and in which the local subsystems transmit consumption data to the at least one remote subsystem, and wherein the demand control commands comprise rule sets to be interpreted by the remote subsystem to determine when and/or how to alter the operating mode(s) of utility consuming systems in one or more domains.

98. Apparatus according to claim 96 wherein said software is configured to cause said rule sets to be stored by the local subsystems and to permit said rule sets to be replaced or amended from time to time by the remote susbsystem.
